(19) United States
(12) Patent Application Publication
(10) Pub. No.: US 2023/0339353 A1
(43) Pub. Date: Oct. 26, 2023

(54) ELECTRIC VEHICLE CHARGING STATION HAVING ADVANCED METERING SYSTEM

(71) Applicant: Aclara Technologies LLC, St. Louis, MO (US)

(72) Inventors: Jonathan Paul Day, Torrington, CT (US); James Eric Lambert, Sparta, NJ (US); Zachary DeAngelo Keller, New Boston, NH (US); William Fredrick Ansell, III, Dover, NH (US); Jason Lee Perron, Rochester, NH (US)

(21) Appl. No.: 18/137,764

(22) Filed: Apr. 21, 2023

Related U.S. Application Data
(60) Provisional application No. 63/333,983, filed on Apr. 22, 2022.
(60) Provisional application No. 63/349,464, filed on Jun. 6, 2022.

(51) Int. Cl. B60L 53/62; B60L 53/30

(52) U.S. Cl. CPC B60L 53/62; B60L 53/305; B60L 2250/16

(57) ABSTRACT

Advanced metering infrastructure integrated within electric vehicle supply equipment (EVSE). An example EVSE includes a housing, an AMI meter situated within the housing, an output terminal configured to connect to an electric vehicle, an output device, and an EVSE controller situated within the housing. The AMI meter is connected to a power grid. The EVSE controller is connected to the AMI meter, the output terminal, and the output device. The EVSE controller is configured to advertise a first charging current value to the output terminal and receive an indication of a high demand period of the power grid. The EVSE controller is configured to advertise, in response to the indication of the high demand period, a second charging current value to the output terminal, the second charging current value being less than the first charging current value, and provide, via the output device, a notification.

### RELATED APPLICATIONS

This application claims the benefit of U.S. Provisional Patent Application No. 63/349,464, filed Jun. 6, 2022, and U.S. Provisional Patent Application No. 63/333,983, filed Apr. 22, 2022, the entire contents of which are hereby incorporated by reference.

### FIELD

The embodiments disclosed herein relate to advanced metering infrastructure integrated within electric vehicle supply equipment.

### BACKGROUND

The proliferation of electric vehicles has resulted in a significant change to the utility grid load. For example, a single electric vehicle charging load is equivalent to two central-air air conditioning loads. Moreover, electric vehicle charging loads are present year-round. Electric utilities are aware of this ever-increasing demand for electricity and have deployed electric vehicle supply equipment to service electric cars on the grid.

### SUMMARY

Approximately 48 million homes in the United States still contain 100A service to their load centers. As homeowners upgrade equipment in their homes, service may be needed to upgrade the home to accommodate todays increased electrical demand. Electric vehicle supply equipment (EVSE) is now being installed in homes to manage the charging of electric vehicles. These EVSEs add additional strain onto load center, particularly when used in combination with ovens, stoves, dryers, air conditioners, and other high-power appliances.

Embodiments described herein address increased strain on load centers by combining advanced metering infrastructure (AMI) meters with EVSEs. Particularly, an EVSE and an AMI communicate to sense strain on a load center and dynamically adjust advertised current available to an electric vehicle via the EVSE. The EVSE and AMI may be implemented within a shared housing. By combining an EVSE and AMI, strain on load centers may be mitigated without changing existing infrastructure. For example, the AMI senses the load center's current consumption and coordinates with the EVSE to dynamically adjust the EVSE's advertised current capacity. Communication between the AMI and the EVSE occurs locally and ensures that the EVSE and load center always operate within the load center's nameplate rating. In some instances, the EVSE in coordination with the AMI can reduce or temporarily suspend charging of an electric vehicle in response to changing conditions on the electrical grid independent of the load center communication.

Additionally, it may be necessary for an EVSE operator, such as a homeowner, to override commands from the load center so that charging of the electric vehicle commences immediately. For example, when permitted, the EVSE operator can choose to “opt-out” of control from the load center and restore the EVSE to its maximum advertised charging rate for an electric vehicle charging session. While the “opt-out” is active, the EVSE ignores subsequent utility commands until the charging session is complete or is terminated. In some instances, the EVSE provides an indication, such as an audible and/or visual indication, while to convey the status of the EVSE.

According to one example, an EVSE includes an AMI meter connected to a power grid to receive power from the power grid. The EVSE also includes an EVSE controller. The EVSE controller is configured to receive power from the AMI, provide the power to an electric vehicle connected to the EVSE, monitor the power provided to the electric vehicle, detect a fault in the power provided to the electric vehicle, and perform, in response to the fault in the power, a protective operation.

According to another example, an EVSE includes an AMI meter connected to a power grid to receive power from the power grid. The EVSE also includes an EVSE controller. The EVSE controller is configured to detect a charge delay condition, select a randomized time delay, and provide power to a connected electric vehicle according to the randomized time delay.

According to another example, an EVSE includes an AMI meter connected to a power grid to receive power from the power grid, an auxiliary power supply coupled to the EVSE, and an EVSE controller. The EVSE controller is configured to detect a high demand period of the power grid, provide power to the electric vehicle using the auxiliary power supply, detect an end of the high demand period of the power grid, and provide power to the electric vehicle using the power from the power grid.

According to another example, an EVSE includes a housing, an AMI meter situated within the housing, an output terminal configured to connect to an electric vehicle, an output device, and an EVSE controller situated within the housing. The AMI meter is connected to a power grid to receive power from the power grid. The EVSE controller is connected to the AMI meter, the output terminal, and the output device. The EVSE controller is configured to advertise a first charging current value to the output terminal and receive an indication of a high demand period of the power grid. The EVSE controller is configured to advertise, in response to the indication of the high demand period, a second charging current value to the output terminal, the second charging current value being less than the first charging current value, and provide, via the output device, a notification indicating of the high demand period.

In some instances, the output device includes at least one selected from the group consisting of a speaker, a light emitting diode, and a display device. In some instances, the indication of the high demand period of the power grid is a command from an external server associated with the power grid. In some instances, the EVSE controller is further configured to modulate a pulse width modulated (PWM) signal provided to the output terminal to advertise the second charging current value to the output terminal. In some instances, the output terminal includes a SAE J1772 charge coupler. In some instances, the EVSE further includes an input device configured to receive a user input, and the EVSE controller is further configured to receive, from the input device, the user input, and advertise, in response to the user input, the first charging current value to the output terminal. In some instances, the EVSE controller is further configured to ignore, in response to the user input, the indication of the high demand period of the power grid until an end of a charging period of the electric vehicle.

In some instances, the EVSE controller is further configured to detect a fault in the power provided to the output terminal, and perform, in response to the fault in the power, a protective operation. In some instances, the EVSE controller is further configured to control a relay to an “ON” setting to provide power to the electric vehicle, and control, in response to the fault in the power, the relay to an “OFF” setting to stop providing power to the electric vehicle. In some instances, the AMI meter is configured to monitor an amount of power received from the power grid, and report the amount of power received from the power grid to a utility server using an AMI network.

According to another example, an EVSE includes a housing, an AMI meter situated within the housing, an output terminal configured to connect to an electric vehicle, a user interface configured to receive user inputs and to provide notifications, and an EVSE controller situated within the housing. The AMI meter is connected to a power grid to receive power from the power grid. The output terminal includes a first power terminal, a second power terminal, a first communication terminal, and a second communication terminal. The EVSE controller is connected to the AMI meter, the output terminal, and the output device. The EVSE controller is configured to advertise, via the first communication terminal, a first charging current value to the electric vehicle, and receive an indication of a high demand period of the power grid. The EVSE controller is configured to advertise, via the first communication terminal and in response to the indication of the high demand period, a second charging current value to the electric vehicle, the second charging current value being less than the first charging current value, and provide, via the user interface, a notification indicative of the high demand period.

In some instances, the EVSE controller is configured to modulate a pulse width modulated (PWM) signal provided via the first communication terminal to adjust the charging current value advertised to the electric vehicle. In some instances, the second communication terminal is configured to provide an indication of whether the EVSE is receiving power. In some instances, the AMI meter is configured to monitor an amount of power received from the power grid, and report the amount of power received from the power grid to a utility server using an AMI network. In some instances, the user interface includes at least one selected from the group consisting of a speaker, a light emitting diode, a rotary dial, a touch-screen device, and a display device.

In some instances, the EVSE controller is further configured to receive, from the user interface, a user input, and advertise, via the first communication terminal and based on the user input, a third charging current value to the electric vehicle. In some instances, the EVSE controller is further configured to detect a fault in the power provided to the output terminal, and perform, in response to the fault in the power, a protective operation. In some instances, the EVSE controller is further configured to receive, from the user interface, a user input, and advertise, in response to the user input, the first charging current value to the output terminal. In some instances, the EVSE controller is further configured to ignore, in response to the user input, the indication of the high demand period of the power grid until an end of a charging period of the electric vehicle.

In another example, an EVSE includes a housing, an AMI meter situated within the housing, an output terminal configured to connect to an electric vehicle, an input device configured to receive a user input, and an EVSE controller situated within the housing. The AMI meter is connected to a power grid to receive power from the power grid. The EVSE controller is connected to the AMI meter and the output terminal. The EVSE controller is configured to advertise a first charging current value to the output terminal, receive, from the input device, the user input, and enable, in response to the user input, an opt-out setting of the EVSE. The EVSE controller is configured to receive an indication of a high demand period of the power grid, and ignore, in response to the opt-out setting being enabled, the indication of the high demand period of the power grid.

Other aspects of the technology will become apparent by consideration of the detailed description and accompanying drawings.

### BRIEF DESCRIPTION OF THE DRAWINGS

FIG. 1 is a diagram illustrating an example electric vehicle charging system, according to some embodiments.

FIG. 2A is a front view of an example electric vehicle supply equipment, according to some embodiments.

FIG. 2B is a side view of the electric vehicle supply equipment of FIG. 2A, according to some embodiments.

FIG. 2C is a back view of the electric vehicle supply equipment of FIG. 2A, according to some embodiments.

FIG. 3 is a perspective view of another example electric vehicle supply equipment, according to some embodiments.

FIGS. 4A-4D provide an example process of installing the electric vehicle supply equipment of FIG. 3.

FIG. 5 is a circuit diagram of an example electric vehicle supply equipment, according to some embodiments.

FIG. 6 is a block diagram of an example control system of the electric vehicle supply equipment of FIG. 5, according to some embodiments.

FIG. 7 is a block diagram of another example control system of the electric vehicle supply equipment of FIG. 5, according to some embodiments.

FIG. 8A is a block diagram of the control system of FIG. 7 integrated with a housing, according to some embodiments.

FIG. 8B is an example user interface integrated in the housing of FIG. 8A, according to some embodiments.

FIG. 9 is a block diagram of an adapter board implemented within the electric vehicle supply equipment of FIG. 5, according to some embodiments.

FIG. 10 is a block diagram illustrating the adapter board of FIG. 9, according to some embodiments.

FIG. 11 is a block diagram illustrating a network implementing the electric vehicle supply equipment of FIG. 5, according to some embodiments.

FIG. 12 is a flow chart illustrating a method for performing protective operations with the example electric vehicle supply equipment of FIG. 5, according to some embodiments.

FIG. 13 is a flow chart illustrating a method for delaying charging of an electric vehicle, according to some embodiments.

FIG. 14 is a flow chart illustrating a method of implementing an auxiliary power supply, according to some embodiments.

FIG. 15 is a flow chart illustrating a method of adjusting current advertised to an electric vehicle, according to some embodiments.

FIG. 16 is a flow chart illustrating a method of implementing an opt-out setting, according to some embodiments.

FIG. 17 is a diagram of a switchboard, according to some embodiments.

FIG. 18 is a flow chart illustrating a method of reducing charge current provided to an electric vehicle, according to some embodiments.

FIG. 19 is a flow chart illustrating a method of adjusting a charge rating of the electric vehicle supply equipment of FIG. 5, according to some embodiments.

### DETAILED DESCRIPTION

One or more examples, embodiments, aspects, and features are described and illustrated in the following description and accompanying drawings. These examples are not limited to the specific details provided herein and may be modified in various ways. Other examples and embodiments may exist that are not described herein. For instance, a device or structure that is “configured” in a certain way is configured in at least that way but may also be configured in ways that are not listed. Some examples described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not include a transitory, propagating signal. Accordingly, non-transitory computer-readable medium may include, for example, a hard disk, a CD-ROM, an optical storage device, a magnetic storage device, ROM (Read Only Memory), RAM (Random Access Memory), register memory, a processor cache, other memory and storage devices, or combinations thereof.

The phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Relational terms, for example, first and second, top and bottom, and the like may be used herein solely to distinguish one entity or action from another entity or action without necessarily requiring or implying any actual such relationship or order between such entities or actions. Embodiments or portions of an embodiment can be combined with other embodiments or portions of other embodiments to create yet further embodiments, whether or not they are specifically illustrated or described.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

In some instances, method steps are conducted in an order that is different from the order described. Additionally, in some instances, rather than occurring concurrently, some method steps may instead occur simultaneously.

### Electric Vehicle Charging Systems

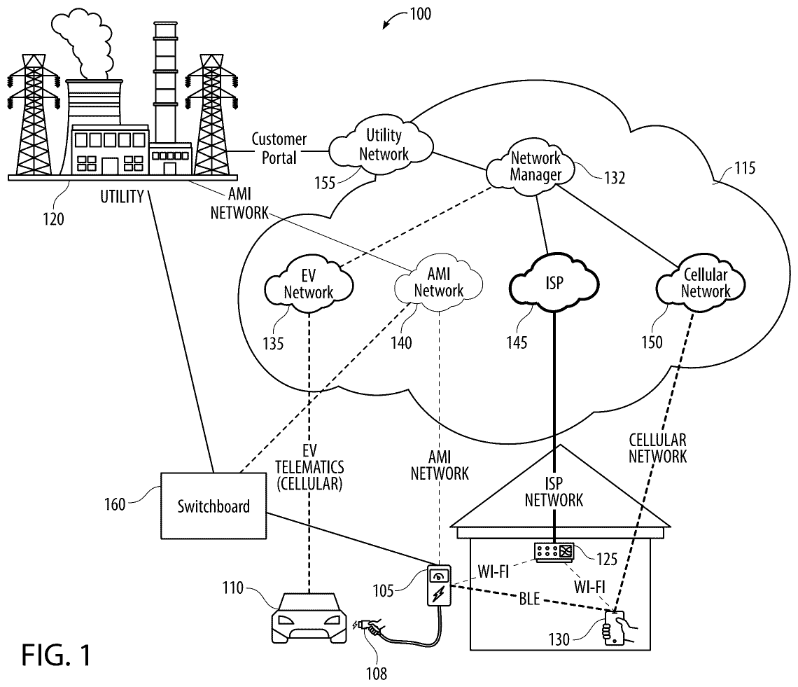

FIG. 1 illustrates an example charging system 100 including an electric vehicle supply equipment (EVSE) 105 and an electric vehicle 110 (for example, a plug-in electric vehicle or a plug-in hybrid electric vehicle). The EVSE 105 is configured to supply power to the electric vehicle 110 via a charging receptacle (e.g., a charging outlet, a charging port) 108. The charging receptacle may be, for example, a SAE J1772 charging port, an IEC 61851 charging port, an IEC 62196 charging port, a Combined Charging Standard (CCS)-type charging port, or other similar charging receptacle. In some instances, multiple electric vehicles 110 are connected to and receive power from the EVSE 105. The EVSE 105 is electrically connected to an electrical grid, such as utility 120 or a load center. The EVSE 105 also includes an advanced metering infrastructure (AMI), described below in more detail.

The charging system 100 further includes a network 115 including a plurality of sub-networks, such as, but not limited to, an electric vehicle network 135, an AMI network 140, an internet service provider (ISP) 145, a cellular network 150, and a utility network 155. In some instances, the network 115 includes a network manager 132 configured to control communications between each of the sub-networks, allowing each device within the charging system 100 to be communicatively connected.

In the example of FIG. 1, the electric vehicle 110 is communicatively coupled to the electric vehicle network 135. The electric vehicle network 135 provides, for example, global positioning system (GPS) information to the electric vehicle 110, troubleshooting information related to a status of the electric vehicle 110, and other operational data to the electric vehicle 110. The electric vehicle 110 provides, for example, status reports, charging information, positioning information, and other operational information to the electric vehicle network 135.

The EVSE 105 is communicatively coupled to a utility 120 (or, more particularly, a server associated with a utility service) via the AMI network 140. In some instances, the EVSE 105 provides status reports to the utility 120 via the AMI network 140, such as, for example, a charging schedule of the electric vehicle 110, an average charging power provided to the electric vehicle 110, a monthly charging power provided to the electric vehicle 110, and which electric vehicles 110 are registered with the EVSE 105. The utility 120 may transmit request signals to the EVSE 105, such as a request for the charging schedule of the EVSE 105, a request for the average charging power provided by the EVSE 105, a request for monthly charging power provided by the EVSE 105, and a request for a list of electric vehicles 110 registered with the EVSE 105. In some instances, the utility 120 transmits commands to the EVSE 105, such as remote disconnect commands to stop transmission of power by the EVSE 105, a current value or charge capacity to advertise to the electric vehicle 110, or the like.

In some instances, the EVSE 105 is communicatively coupled to a router 125 via, for example, Wi-Fi. The router 125 is then communicatively coupled to an internet service provider (ISP) 145 within the network 115. In further implementations, the EVSE 105 is communicatively coupled to a mobile device 130 via, for example, Bluetooth™. The mobile device 130 may be communicatively coupled to a cellular network 150.

A customer may access their utility account via the utility network 155 and the customer portal. The utility account may allow the customer or user to view settings of their EVSE 105, control charging schedules associated with the EVSE 105, override charging of the electric vehicle 110, adjust settings of the EVSE 105, and the like.

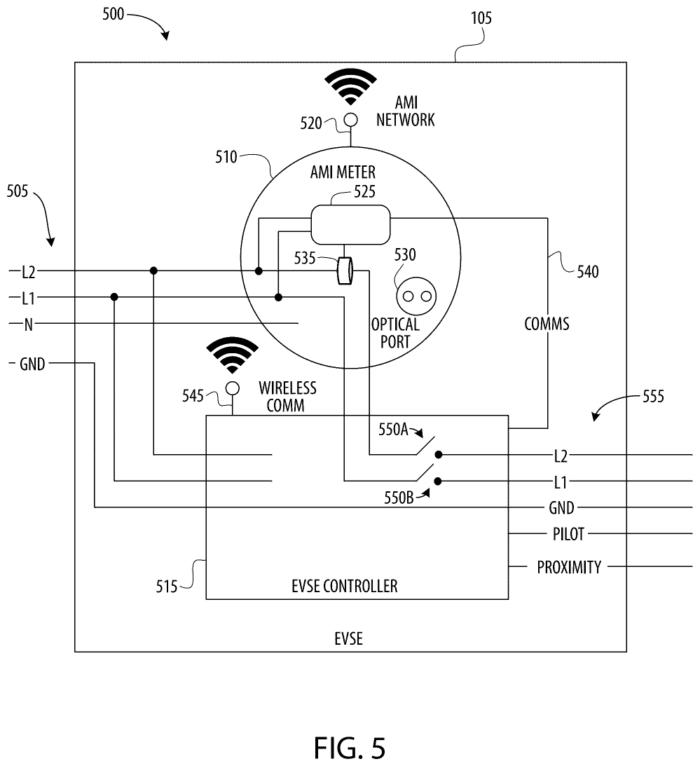

In some instances, the charging system 100 includes a main switchboard 160 (e.g., a panel, a fuse box, a distribution panel, a panel box, a breaker box, etc.) connected between the utility 120 and the EVSE 105. In some instances, the main switchboard 160 includes a house meter (not shown) to measure power usage of all components within a residence. Accordingly, in such an instance, the EVSE 105 is a sub-meter to the house meter. In other instances, the house meter is located separately from the main switchboard 160. In some embodiments, an AMI 510 included in the EVSE 105 (shown in FIG. 5) functions as the house meter.

The main switchboard may trip a fuse or breaker when the current flowing from the utility 120 through the main switchboard exceeds a maximum current, such as 100 Amperes, to prevent damage to the EVSE 105 and the electric vehicle 110. In some embodiments, this may be corrected by reducing a rating of the EVSE 105 when the current draw from the main switchboard 160 exceeds the maximum current. The main switchboard 160 may also be configured to provide power to other electrical appliances, such as household appliances, chargers, and the like that are also connected to the main switchboard 160 to receive power from the utility 120.

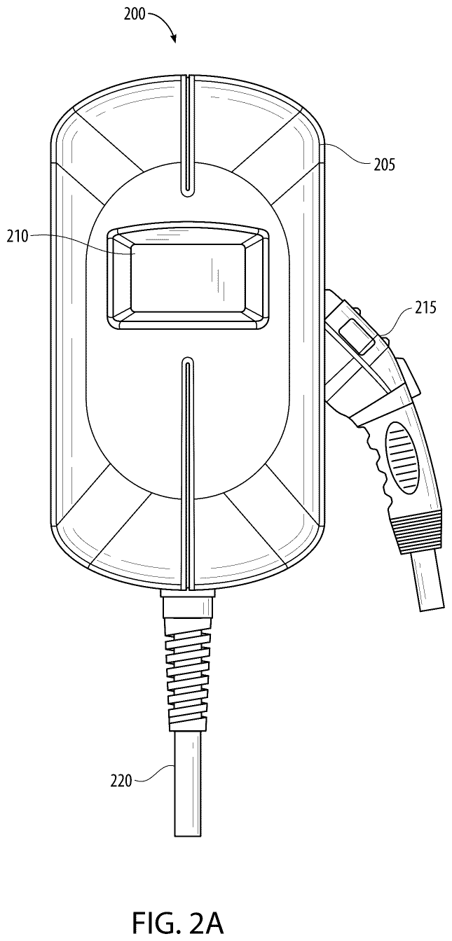

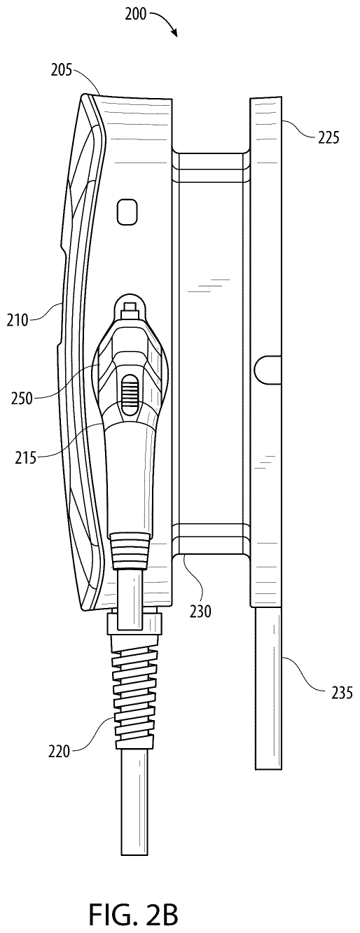

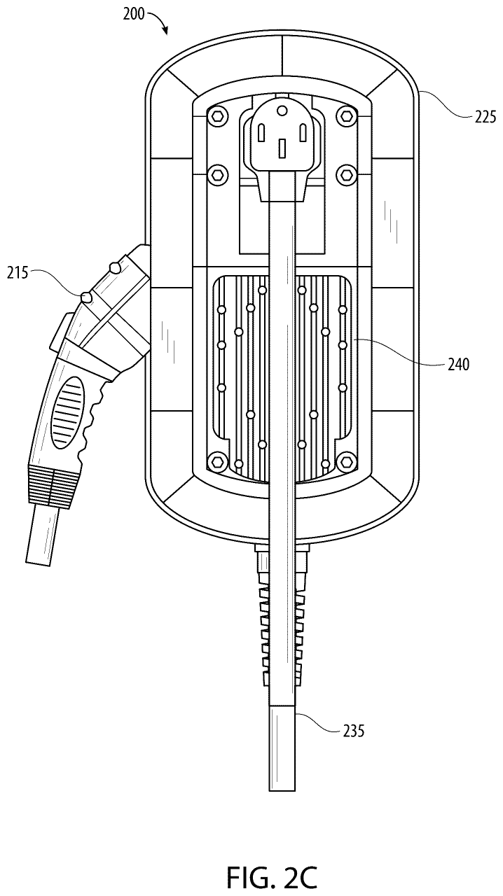

FIG. 2A provides a front view of an example EVSE 200. FIG. 2B provides a side view of the example EVSE 200. FIG. 2C provides a rear view of the example EVSE 200. The EVSE 200 may, for example, be implemented as the EVSE 105 of FIG. 1. The EVSE 200 includes a display 210 and a charging receptacle 215 integrated within a front housing 205. The charging receptacle 215 corresponds with the charging receptacle 108 illustrated in FIG. 1. Power is provided from the EVSE 200 to the electric vehicle 110 via the charging receptacle 215. The charging receptacle 215 is coupled to the EVSE 200 via a charging cord 220, which provides a channel for power traveling from the EVSE 200 and out of the charging receptacle 215. In some implementations, the front housing 205 includes a holder 250 for holding the charging receptacle 215 when the charging receptacle 215 is not connected to the electric vehicle 110. In the illustrated example of FIG. 2B, the holder 250 is a mold or intrusion integrated within the front housing 205 to hold the charging receptacle 215. In other instances, the holder 250 may comprise of protrusions extruding from the front housing 205 to hold the charging receptacle 215.

The EVSE 200 includes a rear housing 225 coupled to the front housing 205 by a middle housing 230. The rear housing 225 includes a coupling interface 240 configured to attach the EVSE 200 to a stand or a wall. Additionally, the rear housing 225 includes a power cable 235 configured to connected to, for example, an electrical grid (e.g., the utility 120) such that the EVSE 200 receives power from the electrical grid.

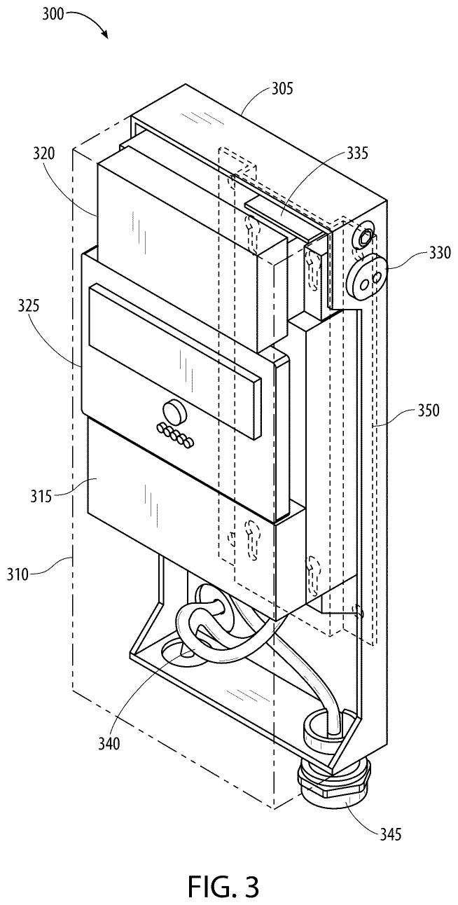

FIG. 3 provides a perspective view of another example EVSE 300. The EVSE 300 may, for example, be implemented as the EVSE 105 of FIG. 1. The EVSE 300 includes a back housing 305 (e.g., a first housing) and a front housing 310 (e.g., a second housing) collectively forming an EVSE housing. An EVSE module 315, AMI module 320, and user interface module 325 are integrated within the EVSE housing. In some embodiments, the EVSE module 315, the AMI module 320, and the user interface module 325 are coupled together and coupled to the back housing 305. The user interface module 325 may include a user interface to interact with the EVSE module 315 and/or the AMI module 320, as described below in more detail.

The EVSE 300 may also include an optical port 330 and an antenna 335. The optical port 330 allows an operator or technician of the EVSE 300 to access software and memory associated with the EVSE 300. For example, an external device may connect to the EVSE 300 via a wireless or physical connection using the optical port 330. In some embodiments, the optical port 330 is integrated into the back housing 305. As one example, the optical port 330 may be accessed via a USB device that magnetically connects to the optical port 330. As another example, an external device magnetically connects to the optical port 330 and communicates wirelessly with the EVSE 300, allowing bidirectional communication between the EVSE 300 and, for example, a computer used by a utility technician. In some embodiments, the optical port 330 is configured as a D-ring. The antenna 335 allows the EVSE 300 to communicate wirelessly over a communication network, such as with the utility 120 over the AMI network 140. The EVSE 300 includes one or more wires 340 connecting the EVSE module 315 to a charging port 345 and to an electrical grid (such as the utility 120). To connect the EVSE 300 to a wall, the back housing 305 is coupled to a mounting structure 350.

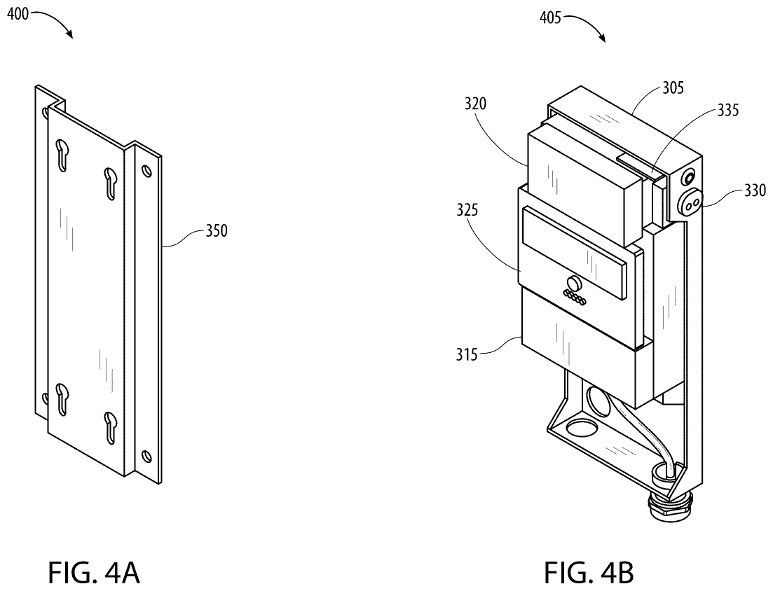

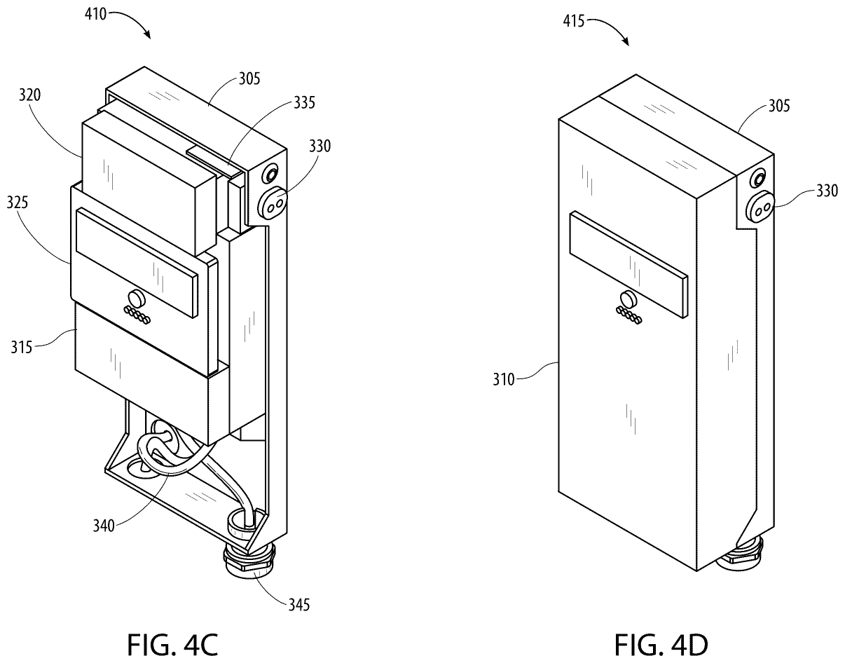

FIGS. 4A-4D illustrate a method of installing the EVSE 300. At step 400 (shown in FIG. 4A), the mounting structure 350 is secured to a wall. At step 405 (shown in FIG. 4B), the back housing 305 is secured to the mounting structure 350. For example, the back housing 305 may be removably coupled to the mounting structure 350 via one or more fasteners. In the example of FIG. 4B, the EVSE module 315, the AMI module 320, the user interface module 325, and the antenna 335 are coupled to the back housing 305.

At step 410 (shown in FIG. 4C), one or more wires 340 are installed to electrically couple the EVSE module 315 to the charging port 345 and to a power source (such as an electric grid). At step 415 (shown in FIG. 4D), the front housing 310 is coupled to the back housing 305.

While several examples of EVSEs have been provided (such as EVSE 200 and EVSE 300), embodiments described herein may instead simply refer to EVSE 105 for the sake of simplicity. Additionally, EVSEs described herein are not merely limited to the examples provided herein, and components may be omitted or additional components may be included in EVSEs than only those shown.

FIG. 5 provides a control system 500 for the EVSE 105. The EVSE 105 receives power from a power input 505 (such as the power cable 235). In the illustrated example, the power input 505 is a NEMA 14-50 receptacle. However, other means for providing power to the EVSE 105 from a power grid may be used. For example, the EVSE 105 may be hardwired to the power grid, or another receptacle may be used. The power input 505 includes a first line power L1, a second line power L2, a neutral line N, and a ground line GND. The first line power L1, the second line power L2, and the neutral line are provided to an AMI meter 510 integrated within the EVSE 105. The first line power L1, the second line power L2, and the ground line GND are provided to an EVSE controller 515. The EVSE 105 may be configured to receive, for example, approximately 12 kW of power on a single-phase AC line. The AMI meter 510 may be integrated in the AMI module 320. The EVSE controller 515 may be integrated in the EVSE module 315.

The AMI meter 510 is configured to monitor power usage of the EVSE 105 via a sensor 535 (e.g., a voltage sensor, a current sensor, a power sensor, and the like). The AMI meter 510 includes an AMI antenna 520 (for example, the antenna 335) configured for bi-directional communication over the AMI network 140. In some implementations, the AMI meter 510 includes an AMI controller 525. The AMI controller 525 includes an electronic processor and a memory (not shown). The AMI controller 525 is configured to communicate with the utility 120 using the AMI antenna 520. For example, the AMI controller 525 reports an amount of power used to charge a connected electric vehicle 110 to the utility 120 via the AMI network 140. The AMI controller 525 also receives requests and commands from the utility 120, such as requests for status reports and remote disconnect commands (as described below in more detail). The AMI antenna 520 may communicate over the AMI network 140 via, as some examples, radio frequency (RF), RF mesh, cellular power line carrier, ethernet, and other similar long-distance communication mediums.

In some instances, the AMI meter 510 includes an optical port 530. The optical port 530 may be, for example the optical port 330. An operator of the AMI meter 510 may access data stored in a memory of the AMI controller 525, or otherwise service the AMI meter 510, via the optical port 530. In some instances, the AMI meter 510 is a single-phase residential ANSI C12 AMI. In some implementations, the AMI meter 510 includes interchangeable automated meter reading (AMR) and AMI modules.

In the example of FIG. 5, the EVSE controller 515 is powered by the first line power L1 and the second line power L2. The first power line L1 and the second power line L2 also travel through the AMI meter 510 (such that power along the lines is monitored) and provided to the EVSE controller 515 before being output at a power output 555 (e.g., the power receptacle 108). In the illustrated example, the power output 555 is an SAE J1772 charge coupler. However, other power receptacles may be implemented. By providing power to the EVSE controller 515 separately from the power provided to the electric vehicle 110, the AMI meter 510 monitors power used to charge the electric vehicle 110 separately from power used by the overall charging system 100. Additionally, in some embodiments, the power output 555 includes a communication terminal such that the EVSE 105 communicates with a connected electric vehicle 110, such as the PILOT terminal and PROXIMITY terminals shown in FIG. 5. For example, the EVSE 105 uses the PILOT terminal (e.g., a control pilot signal) to vary the current advertised to the electric vehicle 110. An advertised current may be a current value that the EVSE 105 tells the electric vehicle 110 is the maximum available current to be drawn for charging. The electric vehicle 110 then adjusts how much current is drawn for charging using electrical components within the electric vehicle 110. In some embodiments, the EVSE 105 indicates a maximum current value, a minimum current value, an intermediate current value, or no current value over the PILOT terminal. For example, the maximum current value may be a maximum current value that the electric vehicle 110 can safely pull, a minimum current value may be a minimum current value output by the EVSE 105 for charging, and a no current value may indicate that charging should not occur during this time. The EVSE 105 uses the PROXIMITY terminal to notify the electric vehicle 110 that the electric vehicle 110 is connected for charging. Accordingly, in some instances, the PILOT terminal and the PROXIMITY terminal are each communication terminals between the EVSE 105 and the electric vehicle 110.

The EVSE controller 515 includes an electronic processor and a memory (not shown). The memory includes, for example, a program storage area and a data storage area. The program storage area and the data storage area can include combinations of different types of memory, such as read-only memory (ROM) and random access memory (RAM). Various non-transitory computer readable media, for example, magnetic, optical, physical, or electronic memory may be used. The electronic processor is configured to implement data stored by the memory to perform operations and methods described herein.

The EVSE controller 515 may also be communicatively coupled to the AMI meter 510 via a communication line 540. The communication line 540 may be wired or wireless. The AMI meter 525 may transmit commands to the EVSE controller 515 based on signals received from the utility 120. For example, the utility 120 may wish to halt providing power via the power output 555 in response to a non-payment, for an emergency cut-off, for a demand response event (e.g., load shedding), or other similar situations. The utility 120 transmits a remote disconnect command to the AMI meter 510 via the AMI network 140. The AMI controller 525 receives the command from the utility 120 and transmits a command to the EVSE controller 515 to disconnect power to the power output 555. As one example, the EVSE controller 515 controls a first switch 550A and a second switch 550B to physically disconnect the first line power L1 and the second line power L2 from the power output 555. In other instances, the first switch 550A and the second switch 550B are logically representative of the EVSE controller 515 halting providing power to the power output 555 (such as, for example, setting a logical flag, stopping outputs from the EVSE controller 515, or the like). In some instances, when the EVSE controller 515 halts providing power to the power output 555, the EVSE controller 515 informs the electric vehicle 110 of upcoming actions the EVSE controller 515 will take via the PILOT terminal.

In some implementations, the remote disconnect command received by the AMI meter 510 is translated by the EVSE controller 515 as different current levels to advertise to the electric vehicle 110. In one example, a “remote disconnect ON” command may instruct the EVSE controller 515 to advertise to the electric vehicle 110 the maximum possible current, while a “remote disconnect OFF” command may instruct the EVSE controller 515 to advertise to the electric vehicle 110 the minimum possible current. In another example, the “remote disconnect ON” command may instruct the EVSE controller 515 to advertise to the electric vehicle 110 the maximum possible current, while the “remote disconnect OFF” command may instruct the EVSE controller 515 to advertise that the EVSE 105 is not prepared to charge the electric vehicle 110 or that the EVSE 105 is not capable of charging the electric vehicle 110 (e.g., is not receiving power from the utility 120).

In some implementations, the EVSE controller 515 monitors a presence of the ground line GND. Should an event occur where the ground line GND is no longer present or operational, the EVSE controller 515 controls the first switch 550A and the second switch 550B to disconnect the first line power L1 and the second line power L2 from the power output 555.

In some implementations, the EVSE controller 515 includes an EVSE antenna 545 configured for local wireless communication. For example and with reference to FIG. 1, the EVSE 105 uses the EVSE antenna 545 to communicate with the router 125 over a Wi-Fi network and the mobile device 130 over a BluetoothTM network. The EVSE controller 515 communicates with the mobile device 130 (or another device communicatively coupled to the EVSE controller 515 via the router 125) using the EVSE antenna 545. For example, the mobile device 130 may set settings or configurations of the EVSE controller 515, view energy reports associated with energy provided to an electric vehicle 110, or the like.

In some implementations, the EVSE controller 515 and the AMI meter 510 are separate pluggable modules that plug into a common EVSE housing, allowing for the EVSE controller 515 and the AMI meter 510 to be serviced independently of one another. In some implementations, the EVSE 105 may include a meter shunt in place of the AMI meter 510. During installation, the EVSE 105 is installed with the EVSE controller 515 and the meter shunt. The AMI meter 510 may then be installed in the EVSE 105 in place of the meter shunt after the initial installation.

In some instances, the AMI controller 525 is a master device that transmits command packets (e.g., data packets) to the EVSE controller 515 (which is a slave device). After receiving the command packets, the EVSE controller 515 transmits either a positive or negative acknowledgement to the AMI controller 525. If the AMI controller 525 fails to receive an acknowledgement before a time-out period (for example, 750 ms), or a negative acknowledgement is received by the AMI controller 525, the AMI controller 525 re-transmits the command packet to the EVSE controller 515. Should the transmission fail a predetermined period of times (for example, three times), the AMI controller 525 assumes an error has occurred. In some embodiments, the command packets include 8 data bits, 1 start bit, and 1 stop bit. In some embodiments, the command packets include parity bits. Table 1 provides example command packets transmitted from the AMI controller 525 to the EVSE controller 515.

TABLE 1
Command Packets

| | Message | | | |
|---|---|---|---|---|
| | Response | | | |
| Command | Data | ID | Message Contents | Charger Response |
| Charge control - allow | No | 0xF0 | Not used - set to 0 s | 0xF0 + response byte |
| | | | | (0 = accepted, no error; |
| | | | | otherwise error occurred) |
| Charge control - disallow | No | 0xF1 | Not used - set to 0 s | 0xF1 + response byte |
| | | | | (0 = accepted, no error; |
| | | | | otherwise error occurred) |
| Read charger status | Yes | 0xF2 | Not used - set to 0 s | 0xF2 + response byte (status |
| | | | | bitfields to be defined) |

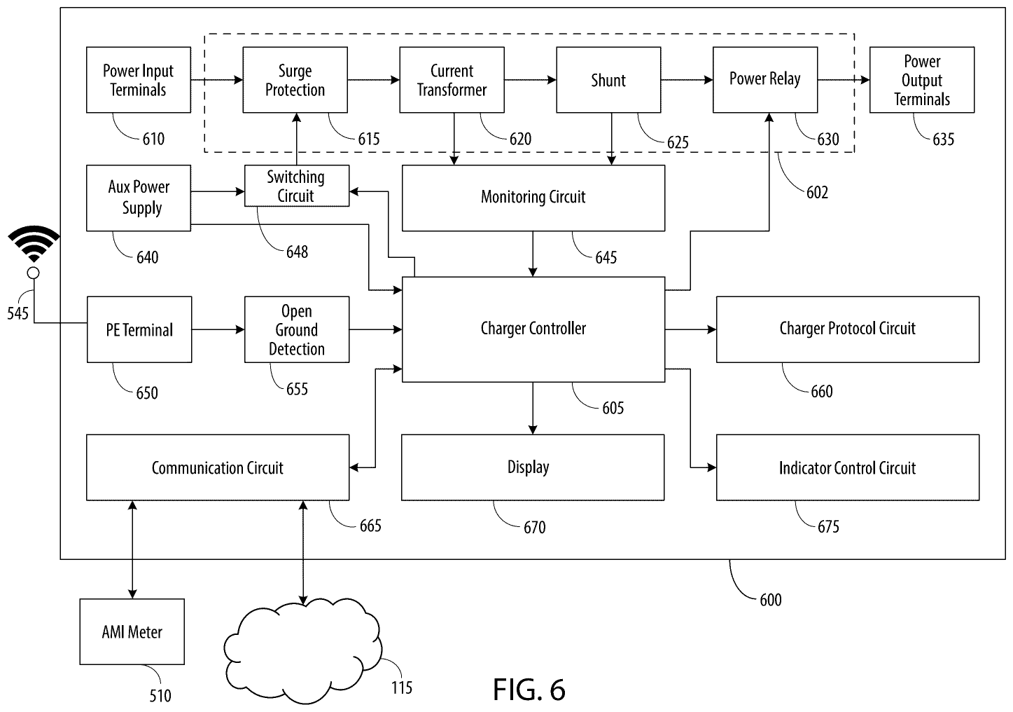

FIG. 6 illustrates an example EVSE controller 600 according to some implementations. The EVSE controller 600 may correspond to the EVSE controller 515 in FIG. 5. The EVSE controller 600 may be implemented in the EVSE module 315 in FIG. 3. The EVSE controller 600 includes power input terminals 610 (e.g., the power input 505), a power circuit 602 comprised of a surge protection circuit 615, a current transformer 620, a shunt circuit 625, a power relay 630 (e.g., first switch 550A and second switch 550B), and power output terminals 635 (e.g., power output 555). The power input terminals 610 receive alternating power from the first power line L1 and the second power line L2. The surge protection circuit 615, the current transformer 620, and the shunt circuit 625 perform conditioning operations on the input power and convert the input power to appropriate power levels for the electric vehicle 110. The surge protection circuit 615 and the shunt circuit 625 also provide protective features should the input power experience a surge in power or otherwise reaches unsafe levels. A charger controller 605 controls the power relay to connect and disconnect the power output terminals 635 from the output of the shunt circuit 625, thereby controlling whether power is provided to the electric vehicle 110. The EVSE controller 600 may control the power relay 630 in response to disconnect commands from the AMI meter 510. When the power relay 630 is in a position to permit transfer of power, power is output to the power receptacle 108 via the power output terminals 635.

In some instances, the charger controller 605 times control of the power relay 630 such that the power relay 630 is controlled only when the AC value of the current through the power circuit 602 is at a zero-value (e.g., zero cross detection). At this moment, no current is flowing through the power circuit 602. By controlling the power relay 630 at this moment, life of the power relay 630 may be extended.

The monitoring circuit 645 is configured to monitor the power provided to the electric vehicle 110 via the power circuit 602 (such as the current traveling through the current transformer 620 or the shunt circuit 625). The monitoring circuit 645 may monitor, for example, leakage current, a value of the alternating current (AC), a power level traveling through the power circuit 602, and the like. The monitoring circuit 645 transmits signals indicative of the power provided to the electric vehicle 110 to a charger controller 605. The charger controller 605 may control the power relay based on the monitored power provided to the electric vehicle 110 exceeding a threshold.

The charger controller 605 includes an electronic processor and a memory. The memory includes, for example, a program storage area and a data storage area. The program storage area and the data storage area can include combinations of different types of memory, such as read-only memory (ROM) and random access memory (RAM). Various non-transitory computer readable media, for example, magnetic, optical, physical, or electronic memory may be used. The electronic processor is configured to implement data stored by the memory to perform operations and methods described herein.

The EVSE controller 600 includes a communication circuit 665 (e.g., the communication line 540) to allow bi-directional communication with the AMI meter 510 and the network 115. The communication circuit 665 may be, for example, the EVSE antenna 545 of FIG. 5.

The PE terminal 650 provides a ground input to the charger controller 605. An open ground detection circuit 455 detects the presence of the ground input at the PE terminal 650. Should the ground input become disconnected or otherwise un-operational, the open ground detection circuit 455 detects the open ground condition and notifies the charger controller 605. The charger controller 605 then controls the power relay 630 to disconnect the power output terminals 635 from the power circuit 602.

In some implementations, the EVSE 105 includes a display 670 to display information related to the operation of the EVSE 105. The display 670 may correspond to the display 210 in FIG. 2A. The charger controller 605 provides, as some non-limiting examples, a remote disconnect status, an estimated mileage of the electric vehicle 110, operational data (e.g., voltage, current, power, charging power, and charging time), fault or error information, a charge history of the electric vehicle 110, a charge status of the electric vehicle 110, and charging rules or guidelines for the electric vehicle 110 on the display 670. In some embodiments, the EVSE 105 also includes a plurality of indicators (for example, LEDs) controlled via an indicator control circuit 675.

In some implementations, the EVSE 105 receives power from an auxiliary power supply 640. The auxiliary power supply 640 may be, for example, photovoltaic cells configured to generate power from solar energy that are stored in a battery, a battery or battery pack configured to be connected to the EVSE 105, or the like. To reduce a load on the utility 120 (e.g., the electrical grid), the charger controller 605 controls a switching circuit 648 to have the auxiliary power supply 640 provide power to the power circuit 602. The auxiliary power supply 640 may be implemented during periods of high usage of the utility 120, during periods of disconnect from the utility 120, or the like. Accordingly, even when the utility 120 is unavailable, the electric vehicle 110 may still be charged by the EVSE 105 using the auxiliary power supply 640. In some implementations, the auxiliary power supply 640 is implemented when rapid charging of the electric vehicle 110 is desired.

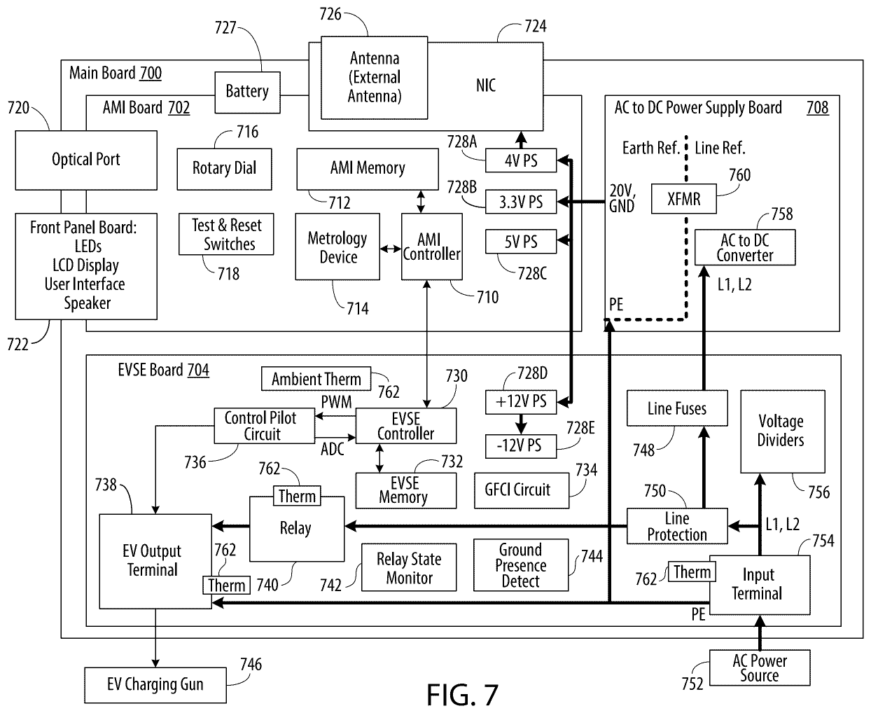

FIG. 7 illustrates a block diagram of an example main board 700 for the EVSE 105. The main board 700 includes an AMI board 702, an EVSE board 704, and an AC-to-DC power supply board 708. While the AMI board 702, the EVSE board 704, and the AC-to-DC power supply board 708 are illustrated separately, in some embodiments, components of the AMI board 702, the EVSE board 704, and the AC-to-DC power supply board 708 may be shared or may be situated differently on the main board 700. Additionally, while direct connections between the various components are not illustrated for the sake of simplicity, one skilled in the art would understand that components situated on the main board 700 would be connected to receive power and communicate in order to perform operations described herein.

The AMI board 702 includes an AMI controller 710, an AMI memory 712, and a metrology device 714. The AMI controller 710 may be or may operate similarly to, for example, the AMI controller 525 of FIG. 5. The AMI memory 712 includes, for example, a program storage area and a data storage area. The program storage area and the data storage area can include combinations of different types of memory, such as read-only memory (ROM) and random access memory (RAM). Various non-transitory computer readable media, for example, magnetic, optical, physical, or electronic memory may be used. The AMI memory 712 includes software implemented by the AMI controller 710 for operation of the AMI meter 510. The metrology device 714 includes devices implemented by the AMI controller 710 for measuring power usage of a connected electric vehicle 110. For example, the metrology device may include the sensor 535. The metrology device 714 may be connected to input terminal 754 to measure power received by the EVSE board 704. In some embodiments, the metrology device 714 is connected to voltage dividers 756, to the first line power L1 and the second line power L2 entering the EV output terminal 738, or a combination thereof.

The AMI board 702 includes a rotary dial 716 for receiving user inputs. For example, a user may operate the rotary dial 716 to select a charge current for the electric vehicle 110. The rotary dial 716 may be a physical rotary dial integrated within a housing of the EVSE 105, or may be a virtual rotary dial implemented on a display device (such as front panel board 722, described below in more detail). The AMI board 702 also includes test and reset switches 718 for testing operation of or resetting the operation of the EVSE 105. The AMI board 702 includes an optical port 720 for receiving an external device. The optical port 720 may operate similarly to, for example, the optical port 330 and/or the optical port 530.

The AMI board 702 includes a front panel board 722. Components of the front panel board 722 are controlled to provide information related to the operation of the EVSE 105. In some instances, components of the front panel board 722 also receive user inputs to set or alter settings of the EVSE 105. The front panel board 722 may include, for example, one or more light emitting diodes (LEDs), a liquid-crystal display (LCD) device, an E Ink™ display, one or more buttons or a touch-screen device forming a user interface, a speaker configured to output audio signals (for example, spoken audio, beeps, tones, and the like), or a combination thereof.

The AMI board 702 includes a network interface controller (NIC) 724 for controlling communication of the EVSE 105 over a wireless communication network (such as the network 115). The NIC 724 includes an antenna 726 for communicating over the wireless communication network. The antenna 726 may operate similarly to, for example, the AMI antenna 520.

In some embodiments, components of the AMI board 702 receive power from a battery 727. The battery 727 may be a rechargeable battery or a replaceable battery. The AMI board 702 may alternatively or additionally receive power from the AC-to-DC power supply board 708. For example, a voltage divider circuit may divide power from the AC-to-DC power supply board 708 into a first power source 728A (e.g., a 4V power source), a second power source 728B (e.g., a 3.3V power source), and a third power source 728C (e.g., a 5V power source), referred to collectively as plurality of power sources 728. More or fewer power sources may be provided based on the operations of the AMI board 702. The first power source 728A may provide power to the NIC 724.

The EVSE board 704 includes an EVSE controller 730 (e.g., a safety controller, a charging controller) and an EVSE memory 732. The EVSE controller 730 may be or may operate similarly to, for example, the EVSE controller 515 of FIG. 5. The EVSE memory 732 includes, for example, a program storage area and a data storage area. The program storage area and the data storage area can include combinations of different types of memory, such as read-only memory (ROM) and random access memory (RAM). Various non-transitory computer readable media, for example, magnetic, optical, physical, or electronic memory may be used. The EVSE memory 732 includes software implemented by the EVSE controller 730 for operation of the EVSE 105.

The EVSE board 704 includes a ground-fault circuit interrupter (GFCI) circuit 734 configured to function as a circuit breaker. For example, the GFCI circuit 734 is connected between an input terminal 754 and relay 740. Should a fault event occur (such as a ground-fault event), the GFCI circuit 734 shuts off power delivery to the relay 740, protecting downstream circuitry of the EVSE board 704.

The EVSE controller 730 controls operation of a control pilot circuit 736. The control pilot circuit 736 outputs the PILOT signal to an EV output terminal 738. The EV output terminal 738 is connected to an EV charging gun 746 that is plugged into an electric vehicle 110. For example, as previously stated, the PILOT signal may indicate a maximum current value, a minimum current value, an intermediate current value, or the like to the electric vehicle 110. The EVSE controller 730 provides a pulse width modulated (PWM) signal to the control pilot circuit 736 to indicate the current value advertised to the electric vehicle 110. The PWM signal may vary between 12 V and −12V, as provided by a fourth power source 728D (e.g., a +12V power source) and a fifth power source 728E (e.g., a −12V power source) from the AC-to-DC power supply board 708. The EVSE controller 730 may modulate the PWM signal provided to the control pilot circuit 736 to adjust a current value advertised to the electric vehicle 110. The control pilot circuit 736 may provide feedback to the EVSE controller 730 via an analog-to-digital converter (ADC) signal. In some embodiments, the ADC signal provides communications from the connected electric vehicle 110 to the EVSE controller 730. For example, the electric vehicle 110 may modulate the PILOT signal to communicate with the EVSE controller 730. The electric vehicle 110 may modulate the PILOT signal to indicate a change in charging current drawn by the electric vehicle 110, to indicate that a protective operation has been performed, or the like.

Power is provided to the input terminal 754 from an AC power source 752, such as an electrical grid. The input power is provided at least as first line power L1 and second line power L2. The input terminal 754 is connected to the EV output terminal 738 such that, when power is received by the input terminal 754, the PROXIMITY signal is transmitted by the input terminal 754 to the EV output terminal 738. In addition to the GFCI circuit 734, extra protection is provided by a line protection circuit 750 (which may provide surge protection, such as the surge protection circuit 615) and line fuses 748. Should a reverse current condition occur (e.g., current flowing from the electric vehicle 110 to the AC power source 752, the line protection circuit 750 may perform a protective operation to disconnect the EVSE 105 from the AC power source 752. A ground presence detection circuit 744 ensures that the EVSE 105 is connected to ground. Should a disconnect occur between the EVSE 105 and ground, the ground presence detect circuit 744 disconnects the EVSE 105 from power until the connection with ground is recovered.

The first line power L1 and the second line power L2 are provided to the EV output terminal 738 via a relay 740. The relay 740 may be controlled by the EVSE controller 730 to provide the first line power Ll and the second line power L2 to the EV output terminal 738 when the PROXIMITY signal indicates that the EVSE 105 is receiving power and an electric vehicle 110 is connected to the EV output terminal 738. The relay 740 may be, for example, a Normally Open Double Pole single Throw DPST relay. The relay 740 may receive power from the fourth power source 728D. A relay state monitor circuit 742 monitors operation of the relay 740. Should a fault of the relay 740 occur (for example, the relay 740 does not open or does not close), the relay state monitor circuit 742 detects the fault and transmits a signal to the EVSE controller 730 indicative of the fault. In some embodiments, the EVSE controller 730 transmits the indication of the fault to the AMI controller 710. The AMI controller 710 controls the front panel board 722 to provide a notification indicative of the fault to a user.

A plurality of thermistors 762 are provided on the main board 700 to monitor temperatures associated with the EVSE 105. In the illustrated example, thermistors 762 are provided to monitor the temperature of the EV output terminal 738, the relay 740, the input terminal 754, and the ambient air temperature. Temperature signals indicating the temperature of the components are provided to the EVSE controller 730. To detect an overtemperature condition, the EVSE controller 730 may compare temperatures indicated by each of the temperature signals from the plurality of thermistors 762 to a temperature threshold. Should any one of the temperatures exceed the temperature threshold, the EVSE controller 730 may perform a protective operation such as controlling the relay 740 to stop charging of the electric vehicle 110 or reduce a charging current provided to the electric vehicle 110. In some embodiments, the EVSE controller 730 compares an average of the temperatures indicated by the temperature signals to a temperature threshold to detect an overtemperature condition.

The AC-to-DC power supply board 708 is configured to convert AC power from the input terminal 754 to DC power utilized by components of the main board 700. The AC-to-DC power supply board 708 includes an AC to DC converter 758 configured to convert power provided on the first line power L1 and the second line power L2 to DC power. A transformer 760 reduces the voltage to a voltage that is safe for use by components of the main board 700. For example, when combined, the AC to DC converter 758 and transformer 760 convert 220V AC power to 20V DC power. The DC power is then provided via the plurality of power sources 728.

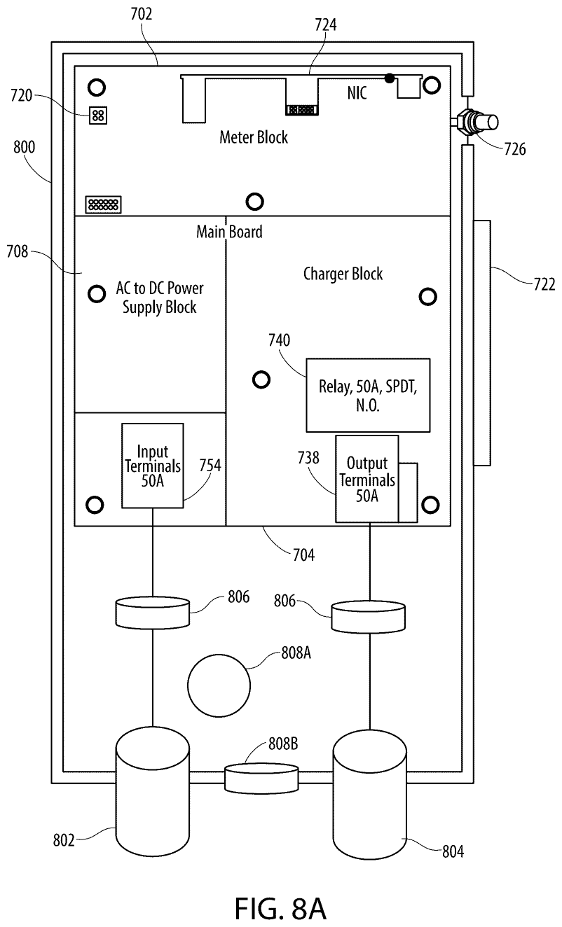

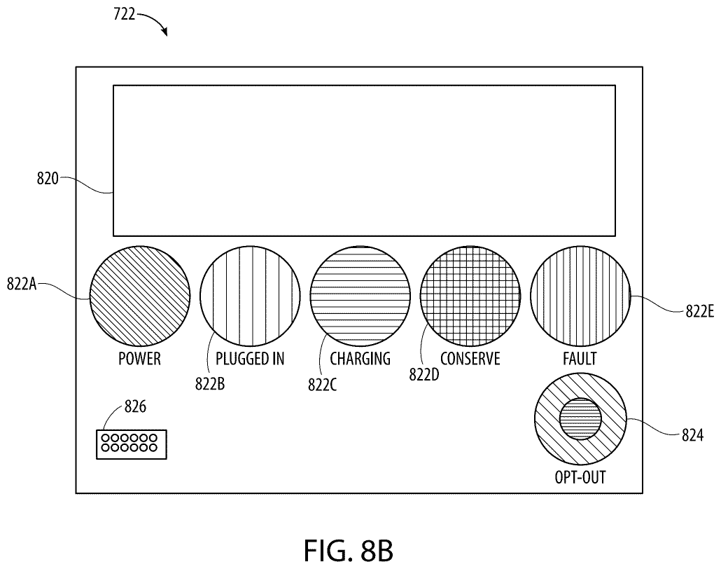

FIG. 8A is a diagram illustrating the main board 700 implemented within an EVSE housing 800. The main board 700 includes the AMI board 702, the EVSE board 704, and the AC-to-DC power supply board 708, as previously discussed. Power enters the EVSE housing 800 via an input power cable 802 that transmits received power to the input terminals 754. The input power cable 802 may be a cable for NEMA 6-50P or NEMA 14-50P installation and may be a double insulated jacketed cable having an M32×1.5 mm cable gland. Power exits the EVSE housing 800 via the EV output terminals 738 that are connected to an output power cable 804. The output power cable 804 may be, for example, the EV charging gun 746. In some instances, the output power cable 804 is a double insulated jacketed cable having an M32×1.5 mm cable gland. Strain relief clamps 806 may be provided to reduce bending and other stresses on the input power cable 802 and output power cable 804. The strain relief clamps 806 may each be aligned with an additional internal strain relief clamp and a terminal bock. In some embodiments, the input power cable 802 and the output power cable 804 are weatherproof.

In some embodiments, the power inputs are hardwired to the EVSE housing 800. For example, a first hardwired line input 808A may be provided on a front surface or a back surface of the EVSE housing 800. The first hardwired line input 808A may be a thermoplastic high heat-resistant nylon-coated (THHN) wiring inside a flexible conduit. The first hardwired line input 808A may fit in a hole having a diameter of approximately 0.75 inches. In another example, a second hardwired line input 806B is provided on a bottom surface of the EVSE housing 800. The second hardwired line input 806B may be a THHN wiring inside a flexible a flexible conduit, and may also fit in a hole having a diameter of approximately 0.75 inches.

In some embodiments, a heat sink (not shown) is provided on a back of the main board 700 to dissipate heat generated by the AMI board 702, the EVSE board 704, and the AC-to-DC power supply board 708.

In some embodiments, the NIC 724 operates at a frequency between approximately 450 MHz to 470 MHz. In other embodiments, the NIC 724 operates at a frequency between approximately 900 MHz and 950 MHz. This radio-frequency bandwidth is sensitive to noise. Noise generated by the AC-to-DC power supply board 708 may impact operation of the NIC 724 and antenna 726. Accordingly, in the example of FIG. 8A, the NIC 724 is situated in an upper corner of the EVSE housing 800 that is opposite a position of the AC-to-DC power supply board 708. The NIC 724 may be situated substantially perpendicular to an upper surface of the EVSE housing 800. Additionally, the antenna 726 is situated on a wall of the EVSE housing 800 that is opposite the AC-to-DC power supply board 708. In some embodiments, the antenna 726 is internal to the EVSE housing 800 and runs along an inner wall of the EVSE housing 800.

A front surface of the EVSE housing 800 includes the front panel board 722, an example of which is shown in FIG. 8B. In the example of FIG. 8B, the front panel board 722 is a user interface that includes a display 820, a plurality of light emitting diodes (LEDs) 822, an input button 824, and a speaker 826. The display 820 may provide information regarding usage of the EVSE 105, such as a current advertised current value, an average power usage, historical usage data, whether the EVSE 105 is connected to the utility 120, whether the utility 120 is experiencing a high demand period, whether a fault event has occurred, or the like. The plurality of LEDs 822 provide additional information regarding the status of the EVSE 105. For example, a first LED 822A may be controlled (for example, by the AMI controller 710) to emit light when the EVSE 105 is receiving power. A second LED 822B may be controlled to emit light when the EVSE 105 is connected to the electric vehicle 110. The third LED 822C may be controlled to emit light when the EVSE 105 is providing a charging current to the electric vehicle 110. The fourth LED 822D may be controlled to emit light when the EVSE 105 is providing a reduced charging current to the electric vehicle 110. The fifth LED 822E may be controlled to emit light when the EVSE 105 is experiencing a fault condition. The plurality of LEDs 822 illustrated in FIG. 8B are examples, and other implementations of the front panel board 722 may include more or fewer LEDs than shown.

The input button 824 allows a user of the EVSE 105 to provide an input to the EVSE 105. For example, the input button 824 may allow a user to enable an “opt-out” setting of the EVSE 105. When the opt-out setting (or Override Demand Response Events setting) is enabled, the EVSE 105 ignores commands from the utility 120 to reduce the charging current advertised to the electric vehicle 110. In some embodiments, additional buttons may be provided on the front panel board 722 to allow a user to provide additional inputs to the EVSE 105. In other embodiments, rather than providing physical, tactile buttons, the display 820 is a touch-screen display configured to receive user inputs. Accordingly, the user of the EVSE 105 may instead select virtual buttons on the display 820 to enable the opt-out setting. The speaker 826 is configured to provide audio notifications indicating the state of the EVSE 105. For example, the speaker 826 output an audio notification (for example, a spoken voice notification) indicating that the utility 120 is experiencing a high demand period and the charging current advertised to the electric vehicle 110 is reduced. In some examples, the speaker 826 outputs an audio notification when the opt-out setting is enabled and/or disabled.

In some embodiments, the EVSE 105 includes a presence sensor to detect whether an operator or user is present and in proximity to the EVSE 105. The presence sensor may be, for example, implemented in the front panel board 722. When a user is present, a component of the front panel board 722 is controlled to indicate the presence of the user. For example, a notification may be provided on the display 820, one of the plurality of LEDs 822 may be controlled to emit light, an audio notification is provided by the speaker 826, or the like.

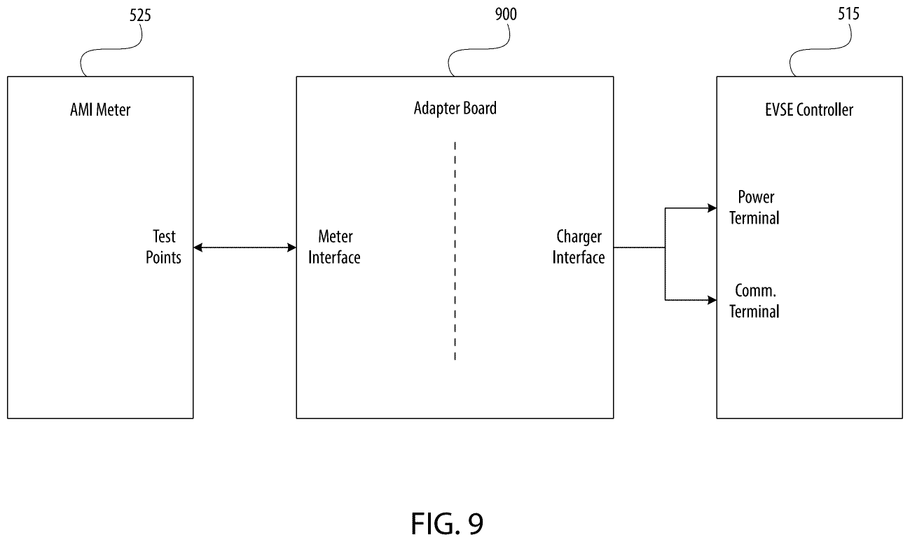

In some instances, an adapter board is situated between the AMI controller 525 and the EVSE controller 515. For example, FIG. 9 illustrates an adapter board 900 connected between the AMI controller 525 and the EVSE controller 515. The adapter board 900 is configured to add isolation capabilities to the control system 500. Additionally, the adapter board 900 is configured to adapt (or convert) the I2C interface of the AMI meter 510 to the communication interface (e.g., a serial UART interface) on the EVSE controller 515. Electrical connections between the adapter board 900, the AMI controller 525, and the EVSE controller 515 may be formed using wiring harnesses.

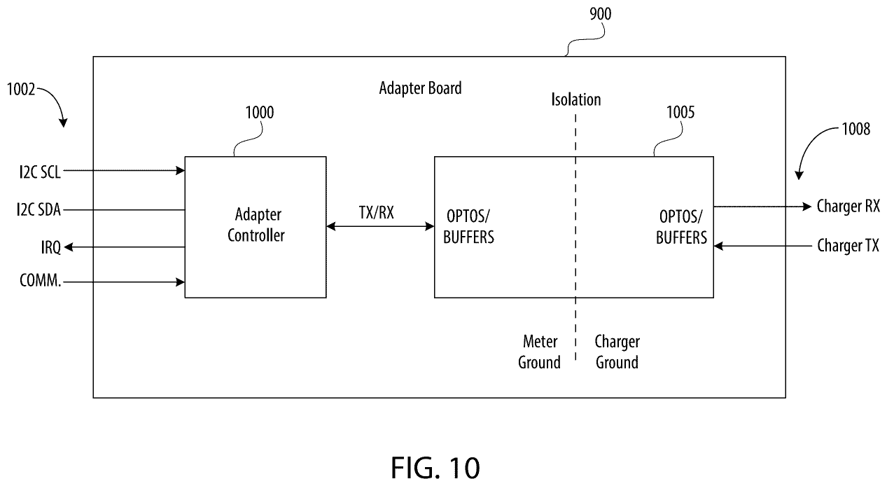

FIG. 10 illustrates an example adapter board 900. The adapter board 900 includes an adapter controller 1000 and an isolation circuit 1005. The adapter controller 1000 is configured to convert the I2C bus of the AMI meter 510 (received via adapter input terminals 1002) to the communication interface of the EVSE controller 515, such as a serial UART interface (provided via adapter output terminals 1008). The isolation circuit 1005 provides isolation between an AMI meter ground (e.g., a line-referenced ground) and an EVSE ground (e.g., an earth-referenced ground).

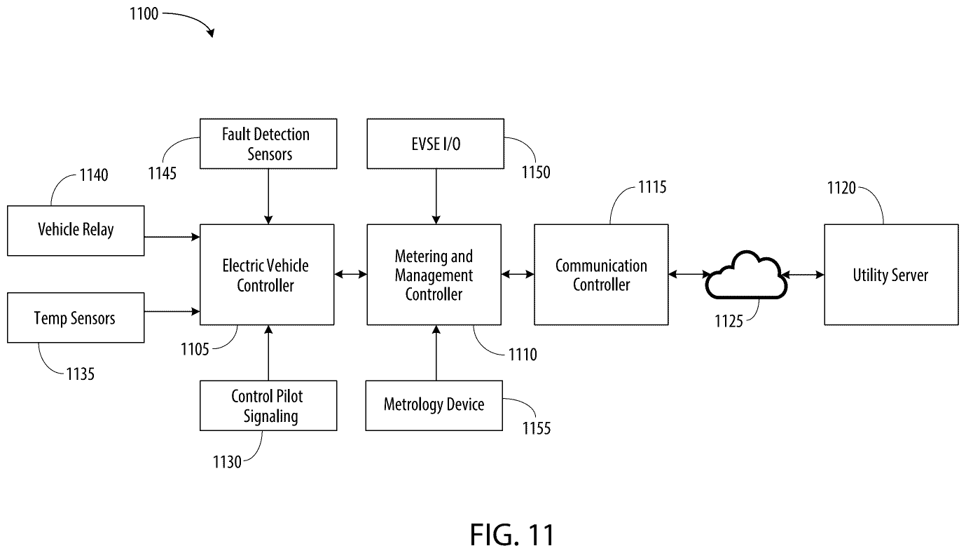

FIG. 11 illustrates a block diagram of a communication system 1100 including, among other things, an electric vehicle controller 1105, a metering and management controller 1110, a communication controller 1115, and a utility server 1120. The communication controller 1115 and the utility server 1120 are communicatively connected via a network 1125. The electric vehicle controller 1105 includes an electronic processor and a memory (not shown). The memory includes, for example, a program storage area and a data storage area. The program storage area and the data storage area can include combinations of different types of memory, such as read-only memory (ROM) and random access memory (RAM). Various non-transitory computer readable media, for example, magnetic, optical, physical, or electronic memory may be used. The electronic processor is configured to implement data stored by the memory to perform operations and methods described herein. The metering and management controller 1110 may perform the operations of the EVSE controller 730 and the AMI controller 710. The communication controller 1115 may be, for example, the NIC 724. In some examples, the operations of the AMI controller 710 are performed by the metering and management controller 1110 in conjunction with the NIC 724.

The electric vehicle controller 1105 is connected to control pilot signaling 1130 (e.g., the PILOT signal), temperature sensors 1135, relay 1140, and fault detection sensors 1145. The electric vehicle controller 1105 sets a value of charging current provided to the electric vehicle 110 based on the current value advertised by the control pilot signaling 1130. The temperature sensors 1135 are internal to the electric vehicle 110 and provide temperature data associated with the electric vehicle 110 to the electric vehicle controller 1105 (for example, a temperature of battery cells being charged). The electric vehicle 110 also includes vehicle relay 1140 to control the flow of power to the electric vehicle 110. The relays 1140 may be synchronized, for example, with the relay 740 in the EVSE 105. Fault detection sensors 1145 detect for faults within the electric vehicle 110 during charging. Should a fault occur, the electric vehicle controller 1105 may halt charging of the electric vehicle 110.

The metering and management controller 1110 is connected to the electric vehicle controller 1105 via the charging cable, such as the EV charging gun 746. The metering and management controller 1110 includes EVSE input/output (I/O) devices 1150 and metrology device 1155. The EVSE I/O devices may include, for example, the front panel board 722 and the rotary dial 716. The metrology device 1155 may be, for example, metrology device 714. In some embodiments, the metering and management controller 1110 communicates with the electric vehicle controller 1105 to perform safety operations, authorize the electric vehicle 110 prior to charging, or the like. The metering and management controller 1110 communicates with the utility server 1120 via the communication controller 1115. For example, the metering and management controller 1110 provides the utility server 1120 with information regarding the power usage of the EVSE 105. Additionally, the utility server 1120 may transmit high demand indications to the metering and management controller 1110.

Accordingly, systems and devices provided herein provide a device including both advanced metering infrastructure and electric vehicle supply equipment within a single housing. The device communicates with a utility to provide power usage information, EVSE status, and receive charging commands. The device provides an advertised current value to a connected electric vehicle via a PILOT command and operates in conjunction with the electric vehicle to control charging. While several examples, embodiments, and implementations have been described herein, different examples, embodiments, and implementations may be altered and combined, and are not limited merely to those explicitly described.

### EVSE Operations

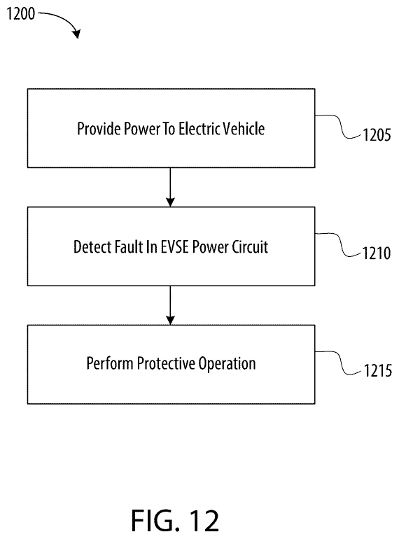

As stated above, the charger controller 605 performs protective operations based on the current flowing through the power circuit 602. FIG. 12 provides a method 1200 performed by the charger controller 605 in accordance with some embodiments of the present disclosure. Although illustrated as occurring sequentially, some of the steps included in the method 1200 may be performed in parallel. Furthermore, it should be understood that in some embodiments, additional steps are added to the method 1200. While method 1200 is described with respect to the charger controller 605, the method 1200 may be implemented by other controllers described herein, such as the EVSE controller 515, the EVSE controller 730, the metering and management controller 1110, the AMI controller 525, the AMI controller 710, or a combination thereof.

At block 1205, the charger controller 605 provides power to the electric vehicle 110. As one example and with reference to FIG. 5, power is provided along the first power line L1 and the second power line L2. The power flows through the AMI meter 510 and the EVSE controller 515. The EVSE controller 515 controls the first switch 550A and the second switch 550B such that power exits the EVSE 105 at the power output terminal 555. As another example and with reference to FIG. 6, the EVSE controller 600 receives power at the power input terminals 610. The charger controller 605 controls the power relay 630 such that power is output at the power output terminals 635.

At block 1210, the charger controller 605 detects a fault in the power circuit 602. As one example and with reference to FIG. 6, the monitoring circuit 645 monitors current flow through the power circuit 602. The monitoring circuit 645 provides signals indicative of the current through the power circuit 602 to the charger controller 605. The charger controller 605 analyzes the signals from the monitoring circuit 645. The charger controller 605 may detect a fault based on the signals from the monitoring circuit 645, such as an overcurrent condition, an overvoltage condition, an undervoltage condition, a ground integrity condition, a ground fault, a temperature condition, and the like. In some instances, the monitoring circuit 645 monitors welded contacts within or associated with the EVSE 105.

In some instances, the monitoring circuit 645 analyzes the current flowing through the power circuit 602 rather than the charger controller 605. Upon detecting a fault condition, the monitoring circuit 645 transmits a signal to the charger controller indicative of the fault condition.

At block 1215, the charger controller 615 performs, in response to the detected fault, protective operations. As one example and with reference to FIG. 5, the EVSE controller 515 controls the first switch 550A and the second switch 550B to disconnect the first power line L1 and the second power line L2 from the power output terminal 555. As another example and with reference to FIG. 6, the charger controller 605 controls the power relay 630 to disconnect the power circuit 602 from the power output terminals 635.

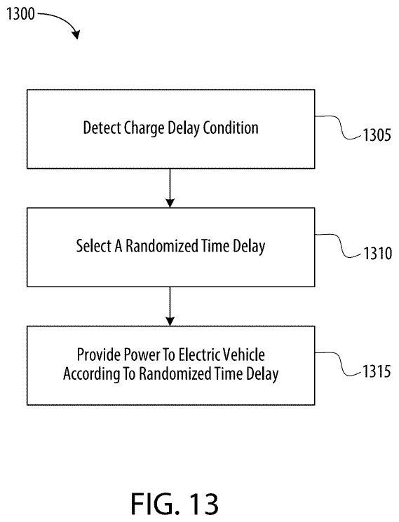

The widespread increase in usage of electric vehicles has caused a new strain on electrical grids. The electric vehicles are commonly connected to a charger for charging in the evening or at otherwise similar times. To offset the sudden surge in power usage due to a restoration of power from power outages or during a peak load time of the electric grid, charging of connected electric vehicles may be delayed. FIG. 13 provides a method 1300 performed by the charger controller 605. Although illustrated as occurring sequentially, some of the steps included in the method 1300 may be performed in parallel. Furthermore, it should be understood that in some embodiments, additional steps are added to the method 1300. While method 1300 is described with respect to the charger controller 605, the method 1200 may be implemented by other controllers described herein, such as the EVSE controller 515, the EVSE controller 730, the metering and management controller 1110, the AMI controller 525, the AMI controller 710, or a combination thereof.

At block 1305, the charger controller 605 detects a charge delay condition. For example, a predetermined time range may be programmed into the charger controller 605. During the predetermined time range, a charge delay condition is set. As another example, the utility 120 may communicate a charge delay condition to the EVSE 105. For example and with reference to FIG. 5, the utility 120 transmits a charge delay condition to the AMI meter 510 via the AMI network 140. The AMI meter 510 provides a signal indicative of the charge delay condition to the EVSE controller 515 via the communication line 540.

At block 1310, the charger controller 605 selects a randomized time delay. At block 1315, the charger controller 605 provides power to the electric vehicle 110 based on the randomized time delay. For example, after the electric vehicle 110 is connected to the EVSE 105, the charger controller 605 delays the start of the charging cycle by a fixed time duration plus a random time duration (T_{EV_Charge_Time_Delay}=T_{Fixed_Time_Delay}+T_{Randomized_Time_Delay}). Once the charge delay time is satisfied, the charger controller 605 controls the power relay 630 to allow charging current to flow through the power output terminals 635.

In some instances, multiple (e.g., two or more) electric vehicles 110 are coupled to an EVSE 105. In this situation, the charger controller 605 may control charging of each electric vehicle 110 separately. As one example, when a first electric vehicle and a second electric vehicle are both coupled to an EVSE 105 for charging, the charger controller 605 selects a first randomized time delay for the first electric vehicle and a second randomized time delay for the second vehicle. In other implementations, the charger controller 605 uses the same randomized time delay for both the first electric vehicle and the second electric vehicle. In such an implementation where multiple electric vehicles 110 are charged, the EVSE 105 includes multiple charging receptacles 108. In some instances, when multiple electric vehicles 110 are charged simultaneously, the EVSE 105 may provide a reduced charging power when compared to the charging power for a single electric vehicle 110. Load balancing and charge prioritization techniques may also be implemented.

In some implementations, to offset the load on the electrical grid, the charger controller 605 ramps up charging of a connected electric vehicle 110 over time. For example, when the electric vehicle 110 is initially connected to the EVSE 105, the charger controller 605 provides a lower charging current (e.g., 10% to 20% of full charging current). Over time, the charger controller 605 ramps up (e.g., increases) the charging current until full charging current is achieved. Ramping up may be a linear ramp, an exponential ramp, or the like. In some implementations, the charger controller 605 provides the lower charging current after the randomized time delay is satisfied. In some instances, to ramp up the value of the charging current to the electric vehicle 110, the charger controller 605 modulates the duty cycle of the charging current. To modulate the duty cycle, as one example, the charger controller 605 modulates the power relay 630 between an “open” or “ON” position and a “closed” or “OFF” position.

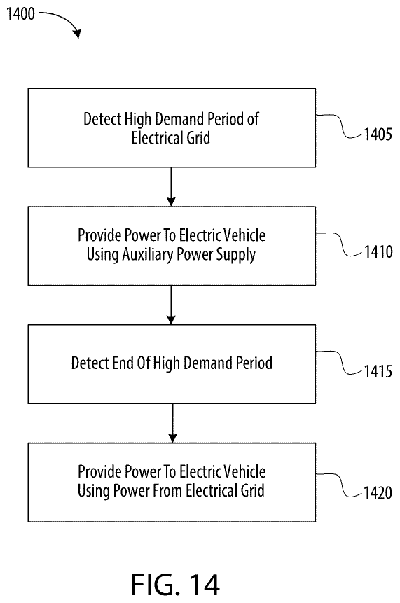

As another example of offsetting or reducing the load on the electrical grid, the charger controller 605 implements an auxiliary power supply 640. FIG. 14 provides a method 1400 performed by the charger controller 605. Although illustrated as occurring sequentially, some of the steps included in the method 1400 may be performed in parallel. Furthermore, it should be understood that in some embodiments, additional steps are added to the method 1400. While method 1200 is described with respect to the charger controller 605, the method 1400 may be implemented by other controllers described herein, such as the EVSE controller 515, the EVSE controller 730, the metering and management controller 1110, the AMI controller 525, the AMI controller 710, or a combination thereof.

At block 1405, the charger controller 605 detects a high demand period of the electrical grid. As one example and with reference to FIGS. 1 and 5, the utility 120 transmits a notification indicative of a high demand period to the EVSE 105 via the AMI network 140. The AMI meter 510 receives the notification via the AMI antenna 520 and transmits the notification to the EVSE controller 515.

At block 1410, the charger controller 605 provides, in response to the high demand period, power to the electric vehicle 110 using the auxiliary power supply 640. As one example and with reference to FIG. 6, the charger controller 605 controls the switching circuit 648 to connect the auxiliary power supply 640 to the power circuit 602. In some implementations, the auxiliary power supply 640 supplements power provided in the power input terminals 610. In other implementations, the power input terminals 610 are disconnected or otherwise are not receiving power from the utility 120.

At block 1415, the charger controller 605 detects an end of the high demand period of the electrical grid. As one example and with reference to FIGS. 1 and 5, the utility 120 transmits a notification indicative of an end of the high demand period to the EVSE 105 via the AMI network 140. The AMI meter 510 receives the notification via the AMI antenna 520 and transmits the notification to the EVSE controller 515. At block 1420, the charger controller 605 provides power to the electric vehicle 110 using power from the electrical grid. As one example and with reference to FIG. 6, the charger controller 605 controls the switching circuit 648 to disconnect the auxiliary power supply 640 from the power circuit 602. The power circuit 602 is then instead provided with only power from the power input terminals 610.

In some implementations, the EVSE 105 receives commands and requests from the mobile device 130. As one example, the mobile device 130 reconfigures settings of the EVSE 105, such as charging times, charging percentages, control of whether the auxiliary power supply 640 is implemented, and the like. A user of the charging system 100 may view the settings of the EVSE 105 via the display 210 (shown in FIG. 2A) or via the mobile device 130.

In some implementations, the EVSE 105 is communicatively coupled with the electric vehicle 110, such as via Wi-Fi, BLE, cellular, or a communication port included in the charging receptacle 108. The electric vehicle 110 may communicate required charging power or charging schedules to the EVSE 105. Accordingly, in such an implementation, the electric vehicle 110 may control its own charging by transmitting commands and schedules to the EVSE 105.

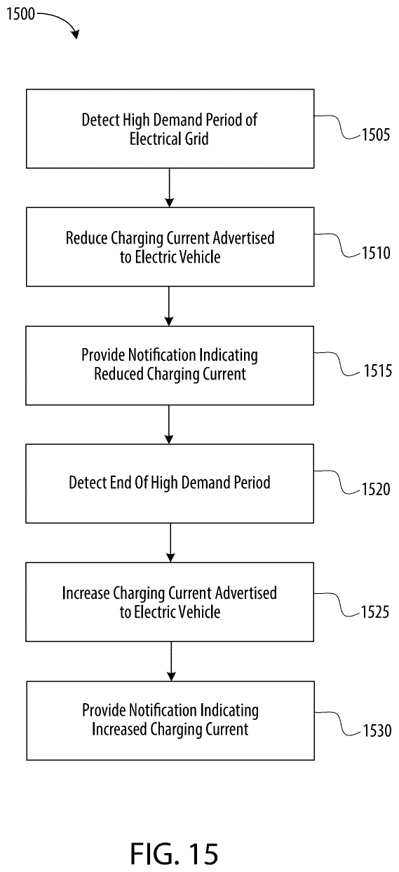

In some instances, the EVSE 105 receives a command from the utility 120 to reduce a charging current value advertised to the electric vehicle 110. FIG. 15 provides a method 1500 performed by the charger controller 605. Although illustrated as occurring sequentially, some of the steps included in the method 1500 may be performed in parallel. Furthermore, it should be understood that in some embodiments, additional steps are added to the method 1500. While method 1500 is described with respect to the charger controller 605, the method 1500 may be implemented by other controllers described herein, such as the EVSE controller 515, the EVSE controller 730, the metering and management controller 1110, the AMI controller 525, the AMI controller 710, or a combination thereof.

At block 1505, the charger controller 605 detects a high demand period of the electrical grid. As one example and with reference to FIGS. 1 and 5, the utility 120 transmits a notification indicative of a high demand period to the EVSE 105 via the AMI network 140. The AMI meter 510 receives the notification via the AMI antenna 520 and transmits the notification to the EVSE controller 515. The notification from the utility 120 may include a duration of the high demand period and may include a current value to advertise to the electric vehicle 110.

At block 1510, the charger controller 605 reduces the charging current advertised to the electric vehicle 110. As one example and with reference to FIG. 7, the EVSE controller 730 controls the relay 740 to reduce the charging current provided to the electric vehicle 110 via the EV output terminal 738. In another example, the EVSE controller 730 adjusts the PWM signal provided to the control pilot circuit 736, thereby modulating the PILOT command. The electric vehicle 110 detects the modulated PILOT command and reduces the charging current used to charge the electric vehicle.

At block 1515, the charger controller 605 provides a notification indicating the reduced charging current. For example, with reference to FIGS. 7 and 8B, the AMI controller 710 outputs a notification via the front panel board 722 indicating the new advertised current. For example, the display 820 is controlled to provide the notification, the fourth LED 822D is controlled to emit light, the speaker 826 is controlled to provide an audio output, or a combination thereof.

At block 1520, the charger controller 605 detects an end of the high demand period of the electrical grid. As one example and with reference to FIGS. 1 and 5, the utility 120 transmits a notification indicative of the end of the high demand period to the EVSE 105 via the AMI network 140. The AMI meter 510 receives the notification via the AMI antenna 520 and transmits the notification to the EVSE controller 515.

At block 1525, the charger controller 605 increases the charging current advertised to the electric vehicle 110. As one example and with reference to FIG. 7, the EVSE controller 730 controls the relay 740 to increase the charging current provided to the electric vehicle 110 via the EV output terminal 738. The charging current may be increased to a default current value. In another example, the EVSE controller 730 adjusts the PWM signal provided to the control pilot circuit 736, thereby modulating the PILOT command. The electric vehicle 110 detects the modulated PILOT command and increases the charging current used to charge the electric vehicle.

At block 1530, the charger controller 605 provides a notification indicating the increased charging current. For example, with reference to FIGS. 7 and 8B, the AMI controller 710 outputs a notification via the front panel board 722 indicating the new advertised current. For example, the display 820 is controlled to provide the notification, the fourth LED 822D is controlled to turn off, the speaker 826 is controlled to provide an audio output, or a combination thereof.

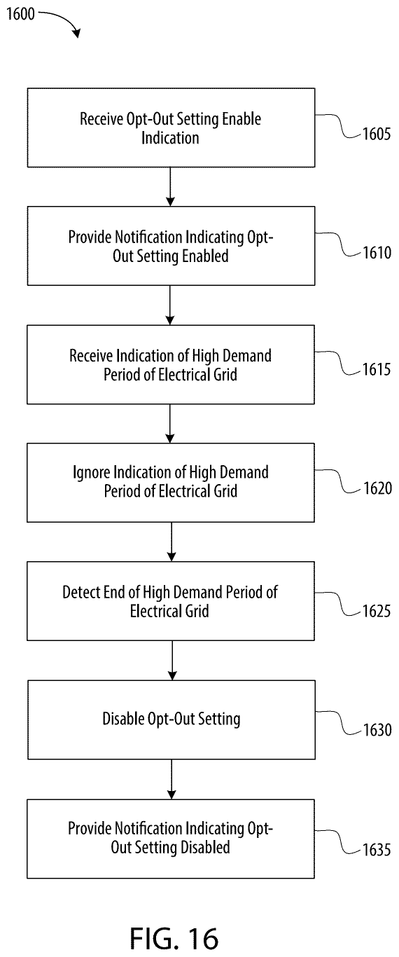

In some instances, a user of the EVSE 105 may opt-out of performing charging commands requested by the utility 120. FIG. 16 provides a method 1600 performed by the charger controller 605. Although illustrated as occurring sequentially, some of the steps included in the method 1600 may be performed in parallel. Furthermore, it should be understood that in some embodiments, additional steps are added to the method 1600. While method 1600 is described with respect to the charger controller 605, the method 1600 may be implemented by other controllers described herein, such as the EVSE controller 515, the EVSE controller 730, the metering and management controller 1110, the AMI controller 525, the AMI controller 710, or a combination thereof.

At block 1605, the charger controller 605 receives an opt-out setting enable indication. For example, with reference to FIGS. 7 and 8B, a user actuates the input button 824 to enable an opt-out setting. The AMI controller 710 detects the actuation of the input button 824. At block 1610, the charger controller 605 provides a notification indicating the opt-out setting being enabled. For example, with reference to FIGS. 7 and 8B, the AMI controller 710 outputs a notification via the front panel board 722 indicating the opt-out setting being enabled. For example, the display 820 is controlled to provide the notification, the speaker 826 is controlled to provide an audio output, an LED of the plurality of LEDs 822 is controlled to emit light, or the like.

At block 1615, the charger controller 605 detects a high demand period of the electrical grid. As one example and with reference to FIGS. 1 and 5, the utility 120 transmits a notification indicative of a high demand period to the EVSE 105 via the AMI network 140. The AMI meter 510 receives the notification via the AMI antenna 520 and transmits the notification to the EVSE controller 515. The notification from the utility 120 may include a duration of the high demand period and may include a current value to advertise to the electric vehicle 110. At block 1620, the charger controller 605 ignores the high demand period of the electrical grid. Accordingly, charging current advertised to the electric vehicle 110 remains constant regardless of the high demand period.

At block 1625, the charger controller 605 detects an end of the high demand period of the electrical grid. As one example and with reference to FIGS. 1 and 5, the utility 120 transmits a notification indicative of the end of the high demand period to the EVSE 105 via the AMI network 140. At block 1630, in response to detecting the end of the high demand period of the electrical grid, the charger controller 605 disables the opt-out setting. In some embodiments, the charger controller 605 disables the opt-out setting in response to a user input. For example, the AMI controller 710 detects actuation of the input button 824. At block 1635, the charger controller provides a notification indicating the opt-out setting being disabled. For example, with reference to FIGS. 7 and 8B, the AMI controller 710 outputs a notification via the front panel board 722 indicating the opt-out setting being enabled. For example, the display 820 is controlled to provide the notification, the speaker 826 is controlled to provide an audio output, an LED of the plurality of LEDs 822 is controlled to emit light, or the like.

In some instances, the EVSE 105 varies the maximum advertised charging current (e.g., maximum advertised EVSE current) provided or communicated to the connected electric vehicle 110 (via the power output 555). For example, the EVSE controller 515 may limit the maximum current according to a breaker threshold, such as transmitting a maximum current of 80% of the breaker size. As one example, an EVSE 105 connected to or including a 50 A breaker may deliver 42 A maximum current. To set the maximum current, the EVSE controller 515 may manipulate or adjust the PILOT control signal transmitted to the electric vehicle 110, as previously described.

In some embodiments, to set the charge current provided from the EVSE 105 to the electric vehicle 110, the utility 120 issues a charge current command over the AMI network 140. The EVSE 105 receives the charge current command (via AMI antenna 520) and sets the desired EVSE charge current to a value indicated by the charge current command. The AMI meter 510 receives and saves the EVSE charge current value to a memory within the AMI controller 525. In some embodiments, the EVSE charge current value is stored in a memory of the EVSE controller 515.

In some instances, the EVSE 105 automatically operates according to the charge current command value. In other instances, the EVSE 105 may wait for an additional command from the utility 120 before operating according to the charge current command value. For example, the utility 120 may communicably issue a unicast, multicast, or broadcast AMI command via the AMI network 140. The EVSE 105 receives the broadcasted AMI command and initiates the stored charge current command value as the maximum current provided to the electric vehicle 110. The AMI command may be transmitted from the utility 120 to a single EVSE, a plurality of EVSEs, or all EVSEs connected to the utility 120 to control the overall load imposed on the utility 120.

In another embodiment, a rotary dial mechanism or a virtual rotary dial (such as rotary dial 716) including a plurality of detents is provided on the EVSE 105. Rotation of the dial increases or decreases the EVSE charge current value. As one example, the dial detents are defined as 100%, 80%, 60%, 40%, and 20% of the breaker size. However, other increments in value may instead be provided. In some embodiments, once the dial is rotated to the lowest value (e.g., 20%), further rotation of the dial wraps around back to the highest value (e.g., 100%).

Once an EVSE charge current value is set using the rotary dial, the AMI controller 525 issues a series of AMI successive commands to move the present EVSE charge current value to the newly desired EVSE charge current value. To avoid single decreasing movement, in some embodiments, the AMI commands must pass the desired EVSE charge current value at least once.

During periods of high demand or emergency situations, the utility 120 implements load shedding functions to remove electrical load from the grid. These functions may not be overridden by a user of the EVSE 105. However, the utility 120 may also implement demand response functions (e.g., demand response events) as a voluntary means to reduce electrical load on the grid. These demand response functions may be overridden by the user of the EVSE 105, such as via the “opt-out” setting as previously described with respect to FIG. 16.

In some instances, rather than simply turning on and off response to demand response events, the EVSE 105 may include a setting to inhibit or ignore the next N demand response events received from the utility 120. In some instances, the EVSE 105 includes a setting to inhibit or ignore all demand response events received for a predetermined time period (e.g., the next four hours). In some instances, the charger controller 605 controls indicators via the indicator control circuit 675 to indicate when a demand response event is active or pending.

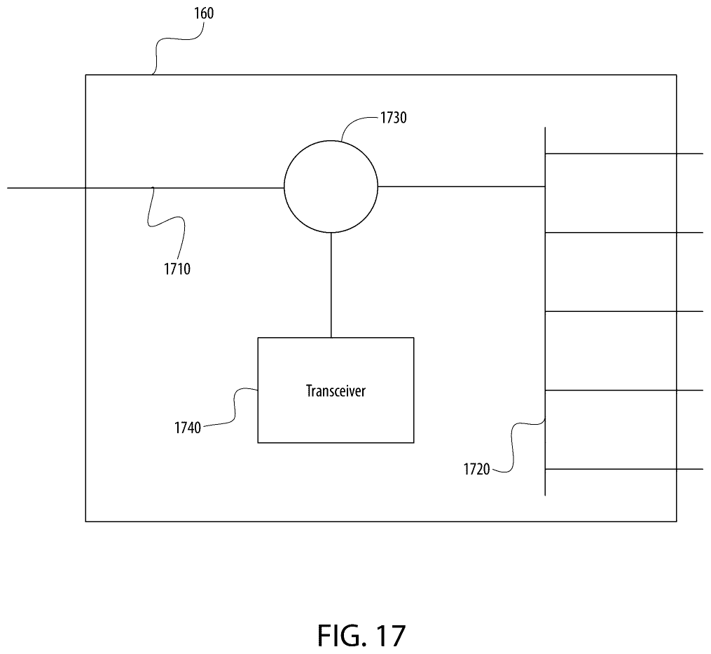

FIG. 17 provides a block diagram of one embodiment of the main switchboard 160. The main switchboard 160 includes a main power line 1710, a switchboard 1720, a current sensor 1730, and a transceiver 1740. The main power line 1710 is connected to the utility 120 to receive electrical power that is then distributed to connected devices, such as the EVSE 105. For example, the main power line 1710 may correspond to the power line 505 in FIG. 5. The current sensor 1730 detects a current flowing through the main switchboard 160. In some embodiments, a circuit breaker (not shown) may also be connected to the current sensor 1730 to cut off a current supply to the household appliances in case of excess current flowing through the main switchboard 160. In some implementations, the functions of the current sensor 1730 are performed by the AMI meter 510.

The transceiver 1740 enables wireless communication from the main switchboard 160 to, for example, the EVSE 105, the utility 120 (via the AMI network 140), and the like. In other embodiments, rather than the transceiver 1740, the main switchboard 160 may include separate transmitting and receiving components, for example, a transmitter and a receiver. In yet other embodiments, the main switchboard 160 may only include a transmitter. The transceiver 1740 may be connected to the current sensor 1730 or to a switchboard electronic processor (not shown) (for example, an electronic processor of a remote computer) connected to the current sensor 1730. The transceiver 1740 is configured to transmit an indication of the amount of current flowing through the main switchboard 160.

In some instances, the EVSE 105 includes a load shedder (not shown) connected on the power line 505. The load shedder may be a charging circuit, or part of a charging circuit of the EVSE 105. The load shedder may receive control signals from the EVSE controller 515. The load shedder reduces the amount of current provided to the electric vehicle 110, and thereby reduces the amount of current drawn from the main switchboard 160. In some instances, the load shedder is implemented as a current limiting circuit. For example, the load shedder is implemented as a variable resistor, a triac, or the like. In another example, the load shedder is implemented as a PWM controlled field effect transistor (FET) circuit or the like.

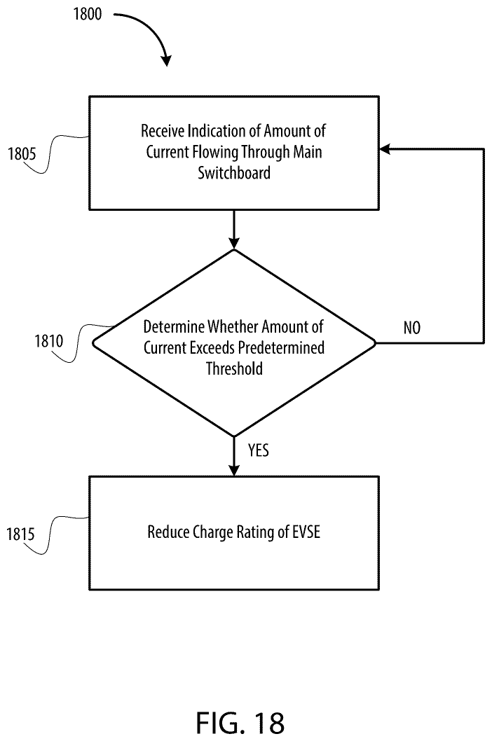

FIG. 18 is a flowchart illustrating one example method 1800 of load shedding. It should be understood that the order of the steps disclosed in method 1800 could vary. Additional steps may also be added to the control sequence and not all of the steps may be required. As illustrated in FIG. 18, the method 1800 includes receiving, at the EVSE controller 515, an indication of an amount of current flowing through the main switchboard 160 (at block 1805). The main switchboard 160 includes the current sensor 1830, which measures a current flowing through the main switchboard 160. The main switchboard 160 may send an indication of the amount of current flowing through the main switchboard 160 via the transceiver 1740 to the EVSE 105. The main switchboard 160 may send the indication periodically, for example, after every 1 millisecond, every 1 second, every 5 seconds, etc.

The method 1800 also includes determining, with the EVSE controller 515, whether the amount of current exceeds a predetermined threshold (at block 1810). The predetermined threshold may be a percentage of the maximum amount of current that can flow through the main switchboard 160 without tripping a fuse or breaker. For example, the predetermined threshold may be 80% of the maximum current. In some embodiments, a default threshold is programmed into the EVSE 105, which may be changed by a user. When the EVSE controller 515 determines that the amount of current does not exceed the predetermined threshold, the method 1600 cycles back to block 1805.

When the EVSE controller 515 determines that the amount of current exceeds the predetermined threshold, a charge rating of the EVSE 105 is reduced (at block 1815). Reducing the charge rating may include reducing an amount of current drawn by the EVSE 105 from the main switchboard 160. The EVSE controller 515 may provide control signals to the load shedder (not shown) instructing the load shedder to reduce the charge rating of the EVSE 105.

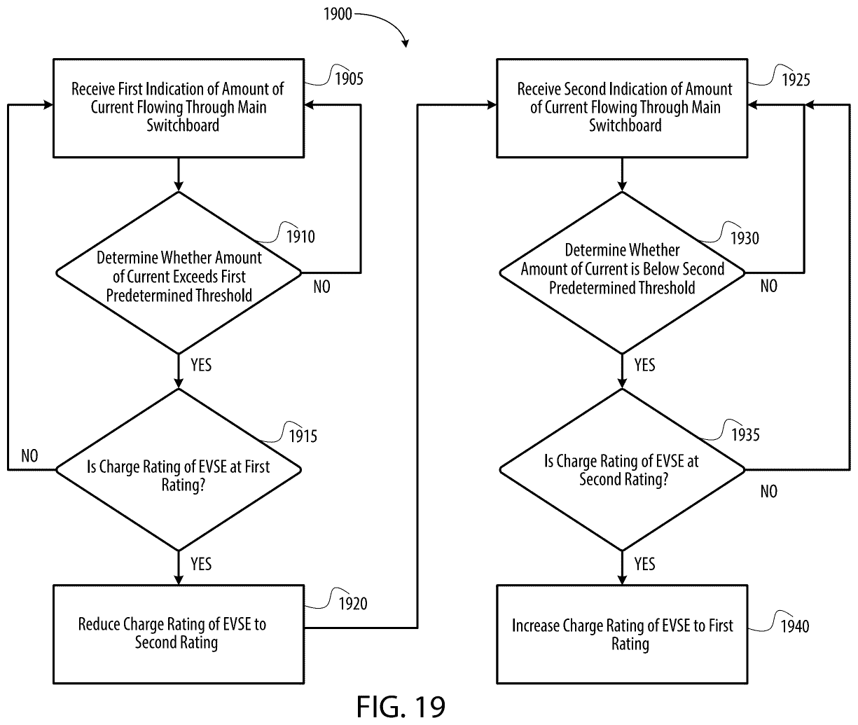

FIG. 19 is a flowchart illustrating another example method 1900 of load shedding. It should be understood that the order of the steps disclosed in method 1900 could vary. Additional steps may also be added to the control sequence and not all of the steps may be required. As illustrated in FIG. 19, the method 1900 includes receiving, at the EVSE controller 515, a first indication of an amount of current flowing through the main switchboard 160 (at block 1905). As described above, the EVSE controller 515 may receive the indication from the main switchboard 160.

The method 1900 further includes determining, with the EVSE controller 515, whether the amount of current exceeds a first predetermined threshold (at block 1910). As described above, the first predetermined threshold may be a percentage of the maximum amount of current allowed to flow through the main switchboard 160. When the EVSE controller 515 determines that the amount of current does not exceed the first predetermined threshold, the method 1900 cycles back to block 1905. When the EVSE controller 515 determines that the amount of current exceeds the first predetermined threshold, the method 1900 includes determining, with the EVSE controller 515, whether a charge rating of the EVSE 105 is at a first rating (at block 1915). For example, the EVSE controller 515 may determine that the EVSE 105 is operating at a maximum rating and drawing a current at the maximum rated amount of the EVSE 105. When the EVSE controller 515 determines that the charge rating of the EVSE 105 is not at the first rating, the method 1900 cycles back to block 1905.

When the EVSE controller 515 determines that the amount of current exceeds the first predetermined threshold and that the charge rating of the EVSE 105 is at the first rating, the method 1900 includes reducing the charge rating to a second rating (at block 1920). The second rating may be a lower rating than the first rating. For example, the second rating may include the EVSE 105 drawing a minimum amount of charging current from the main switchboard 160. For example, the second rating may include operating the EVSE 105 at, for example, approximately 15% of the maximum rated current to approximately 25% of the maximum rated current. In some embodiments, the EVSE controller 515 may turn off charging when the amount of current exceeds the predetermined threshold.

The method 1900 includes receiving, at the EVSE controller 515, a second indication of an amount of current flowing through the main switchboard 160 (at block 1925). The second indication may be received a certain amount of time after the first indication. The method 1900 includes determining, with the EVSE controller 515, whether the amount of current is below a second predetermined threshold (at block 1930). The second predetermined threshold may be lower than the first predetermined threshold. For example, the second predetermined threshold may be set at approximately 35% of the maximum amount of current to approximately 45% of the maximum amount of current allowed to flow through the main switchboard 160. When the EVSE controller 515 determines that the amount of current does not exceed the second predetermined threshold, method 1900 cycles back to block 1925.

When the EVSE controller 515 determines that the amount of current does not exceed the second predetermined threshold, the method 1900 also includes determining, with the EVSE controller 515, whether the charge rating of the EVSE 105 is at the second rating (at block 1935). When the EVSE controller 515 determines that the charge rating of the EVSE 105 is not at the second rating, the method 1900 cycles back to block 1925. When the EVSE controller 515 determines that the amount of current falls below the second predetermined threshold and that the charge rating of the EVSE 105 is at the second rating, the method 1900 includes increasing the charge rating to the first rating (at block 1940). For example, the EVSE controller 515 may determine, based on the second indication, that returning the EVSE 105 to the maximum rating will cause the amount of current flowing through the main switchboard 160 to exceed the maximum allowed current. The EVSE controller 515 may therefore decrease the charge rating of the EVSE 105.

In some embodiments, rather than switching between two charge ratings (i.e., the first rating and the second rating), the EVSE controller 515 may switch the EVSE 105 between multiple charge ratings based on the amount of current flowing through the main switchboard 160.

The current thresholds and charge ratings of the EVSE 105 discussed within methods 1800 and 1900 may be stored in a memory of the main switchboard 160. Alternatively, in some instances, the current thresholds and charge ratings of the EVSE 105 discussed within methods 1800 and 1900 are stored in the memory of the EVSE controller 515.

In some instances, the charge rating of the EVSE 105 is adjusted based on a signal from the utility 120. For example, the utility 120 may transmit a charge rating signal to the main switchboard 160 via the transceiver 1740. The main switchboard 160 provides a command to the EVSE 105 to adjust the charge rating of the EVSE 105. In another embodiment, the utility 120 transmits the charge rating signal to the EVSE 105 directly.

In some implementations, current thresholds and the charge ratings are dynamically calculated during operation of the EVSE 105. For example, while the main switchboard 160 has a constant power rating, the power consumed by the electric vehicle 110 and the other power components within the related residence are dynamic and measurable. To determine whether an overload condition of a residence is imminent, the power measured by the house meter may be compared against the power rating of the main switchboard 160. To assist with dynamically calculating current thresholds and charge ratings, the house meter communicates with the EVSE controller 515 to obtain the dynamic power consumption of the electric vehicle 110. The house meter then computes the real time total power consumption using the power consumption of the electric vehicle 110 and compares the real time total power consumption to the power rating of the main switchboard 160. This comparison is communicated to the EVSE controller 515 to command the EVSE 105 to adjust the ampacity advertised to the electric vehicle 110 over the PILOT terminal. By dynamically adjusting the advertised ampacity, the system maintains power within the power rating of the main switchboard 160 while still ensuring a fast charge rate for the electric vehicle 110. In some instances, the house meter communicates the advertised rate and real time total power consumption to the utility 120.

The charge rating of the EVSE 105, or the output current value advertised to the electric vehicle 110, may be programmatically set in the EVSE controller 515 either locally or remotely and is bound to a maximum ampacity. The EVSE controller 515 may bind the charge rating to a reduced ampacity, such as 80% of the power rating of the main switchboard 160, based on commands from the house meter and/or the utility 120. Additionally, a minimum permissible charge rating of the EVSE 105 may be dynamically adjusted based on commands from the house meter and/or the utility 120.

The power rating of the utility 120 is also dynamic. As loads on the utility 120 change over time, the overall power rating can be computed by predetermining which residential meters (e.g., the house meters) and EVSE 105s are associated with a given transformer. In some instances, the utility 120 also includes a data collection unit that handles communication between one or more AMI meters 510 connected to the utility 120. The data collection unit uses the gas-insulated substations (GIS) and infrastructure data of the utility 120 to model a transformer's load rating and associated loads. For each transformer and associated load, the data collection unit can dynamically compute the difference between the modelled transformer load rating and the calculated connected load. The utility 120 then dynamically commands the house meter and/or EVSE 105 to adjust the advertised ampacity to the electric vehicle 110 to maintain power within the safe operating power rating of the associated transformer.

Thus, the application provides, among other things, advanced metering infrastructure integrated within electric vehicle supply equipment. Various features and advantages of the application are set forth in the following claims.

What is claimed is:

1. An electric vehicle supply equipment (EVSE) comprising:
a housing;
an advanced metering infrastructure (AMI) meter situated within the housing, the AMI meter connected to a power grid to receive power from the power grid;
an output terminal configured to connect to an electric vehicle;
an output device; and
an EVSE controller situated within the housing, the EVSE controller connected to the AMI meter, the output terminal, and the output device, the EVSE controller configured to:
advertise a first charging current value to the output terminal,
receive an indication of a high demand period of the power grid,
advertise, in response to the indication of the high demand period, a second charging current value to the output terminal, the second charging current value being less than the first charging current value, and
provide, via the output device, a notification indicating the high demand period.

2. The EVSE of claim 1, wherein the output device includes at least one selected from the group consisting of a speaker, a light emitting diode, and a display device.

3. The EVSE of claim 1, wherein the indication of the high demand period of the power grid is a command from an external server associated with the power grid.

4. The EVSE of claim 1, wherein the EVSE controller is further configured to modulate a pulse width modulated (PWM) signal provided to the output terminal to advertise the second charging current value to the output terminal.

5. The EVSE of claim 1, wherein the output terminal includes a SAE J1772 charge coupler.

6. The EVSE of claim 1, wherein the EVSE further includes an input device configured to receive a user input, and wherein the EVSE controller is further configured to:
receive, from the input device, the user input, and
advertise, in response to the user input, the first charging current value to the output terminal.

7. The EVSE of claim 6, wherein the EVSE controller is further configured to ignore, in response to the user input, the indication of the high demand period of the power grid until an end of a charging period of the electric vehicle.

8. The EVSE of claim 1, wherein the EVSE controller is further configured to:
detect a fault in the power provided to the output terminal, and
perform, in response to the fault in the power, a protective operation.

9. The EVSE of claim 8, wherein the EVSE controller is further configured to:
control a relay to an “ON” setting to provide power to the electric vehicle, and
control, in response to the fault in the power, the relay to an “OFF” setting to stop providing power to the electric vehicle.

10. The EVSE of claim 1, wherein the AMI meter is configured to:
monitor an amount of power received from the power grid, and
report the amount of power received from the power grid to a utility server using an AMI network.

11. An electric vehicle supply equipment (EVSE) comprising:
a housing;
an advanced metering infrastructure (AMI) meter situated within the housing, the AMI meter connected to a power grid to receive power from the power grid;
an output terminal configured to connect to an electric vehicle, the output terminal including a first power terminal, a second power terminal, a first communication terminal, and a second communication terminal;
a user interface configured to receive user inputs and configured to provide notifications; and
an EVSE controller situated within the housing, the EVSE controller connected to the AMI meter, the output terminal, and the user interface, the EVSE controller configured to:
advertise, via the first communication terminal, a first charging current value to the electric vehicle,
receive an indication of a high demand period of the power grid,
advertise, via the first communication terminal and in response to the indication of the high demand period, a second charging current value to the electric vehicle, the second charging current value being less than the first charging current value, and
provide, via the user interface, a notification indicative of the high demand period.

12. The EVSE of claim 11, wherein the EVSE controller is configured to modulate a pulse width modulated (PWM) signal provided via the first communication terminal to adjust the charging current value advertised to the electric vehicle.

13. The EVSE of claim 11, wherein the second communication terminal is configured to provide an indication of whether the EVSE is receiving power.

14. The EVSE of claim 11, wherein the AMI meter is configured to:
monitor an amount of power received from the power grid, and
report the amount of power received from the power grid to a utility server using an AMI network.

15. The EVSE of claim 11, wherein the user interface includes at least one selected from the group consisting of a speaker, a light emitting diode, a rotary dial, a touch-screen device, and a display device.

16. The EVSE of claim 11, wherein the EVSE controller is further configured to:
receive, from the user interface, a user input, and
advertise, via the first communication terminal and in response to the user input, a third charging current value to the electric vehicle.

17. The EVSE of claim 11, wherein the EVSE controller is further configured to:
detect a fault in the power provided to the output terminal, and
perform, in response to the fault in the power, a protective operation.

18. The EVSE of claim 11, wherein the EVSE controller is further configured to:
receive, from the user interface, a user input, and
advertise, in response to the user input, the first charging current value to the output terminal.

19. The EVSE of claim 18, wherein the EVSE controller is further configured to ignore, in response to the user input, the indication of the high demand period of the power grid until an end of a charging period of the electric vehicle.

20. An electric vehicle supply equipment (EVSE) comprising:
a housing;
an advanced metering infrastructure (AMI) meter situated within the housing, the AMI meter connected to a power grid to receive power from the power grid;
an output terminal configured to connect to an electric vehicle;
an input device configured to receive a user input; and
an EVSE controller situated within the housing, the EVSE controller connected to the AMI meter and the output terminal, the EVSE controller configured to:
advertise a first charging current value to the output terminal,
receive, from the input device, the user input,
enable, in response to the user input, an opt-out setting of the EVSE,
receive an indication of a high demand period of the power grid, and
ignore, in response to the opt-out setting being enabled, the indication of the high demand period of the power grid.
